(19) United States
(12) Patent Application Publication
(10) Pub. No.: US 2013/0070036 A1
(43) Pub. Date: Mar. 21, 2013

(54) INK COMPOSITION, INK SET, AND IMAGE FORMING METHOD

(71) Applicant: Yasufumi OOISHI, Kanagawa (JP)

(72) Inventor: Yasufumi OOISHI, Kanagawa (JP)

(73) Assignee: FUJIFILM CORPORATION, Tokyo (JP)

(21) Appl. No.: 13/567,092

(22) Filed: Aug. 6, 2012

(30) Foreign Application Priority Data
Sep. 16, 2011 (JP) 2011-203637

(51) Int. Cl. B41J 2/01; C08K 5/06; C09D 11/10; C08K 5/07

(52) U.S. Cl. 347/102; 524/364; 524/376

(57) ABSTRACT

The present invention provides an ink set including an ink composition including resin particles including a polymer formed from one or more structural units selected from structural units, which are represented by the following Formula (1) and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group, a polymerizable compound having a (meth)acrylamido structure, water, a pigment, and a polymerization initiator; and a maintenance liquid including a compound having an SP value of from 8.00 (cal/cm³)^{1/2} to 12.00 (cal/cm³)^{1/2}.

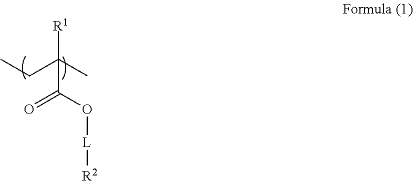

### CROSS-REFERENCE TO RELATED APPLICATION

This application claims priority under 35 USC 119 from Japanese Patent Application No. 2011-203637, filed on Sep. 16, 2011, the disclosure of which is incorporated by reference herein.

### BACKGROUND OF THE INVENTION

1. Field of the Invention

The present invention relates to an ink composition, an ink set, and a method of forming an image.

2. Description of the Related Art

Inkjet technology is known as an image recording method for recording color images. The inkjet technology has been applied to the fields of office printers, home printers, and the like, and is recently being applied to the commercial printing field.

As one of the components contained in ink (an ink composition) used in the inkjet technology, pigments are widely used. Heretofore, various investigations have been made with regard to inks containing a pigment (pigment inks) and image forming methods using the pigment ink.

For example, an ink set including an ink composition containing a pigment, polymer particles, and an aqueous polymerizable compound that undergoes polymerization by irradiation with an actinic energy ray, and a treatment liquid containing an aggregating agent that aggregates components in the ink composition, the ink set exhibiting excellent ink coagulation property and being capable of recording images having excellent abrasion resistance and printing property at a high speed, is known (see, for example, Japanese Patent Application Laid-Open (JP-A) No. 2010-70693).

Further, as an ink set having excellent maintenance property, an ink set including an aqueous ink composition, which has a pH of from 7 to 10 and contains a pigment and polymer particles, and a maintenance liquid for inkjet recording, which contains water, an organic solvent, a basic compound, and an acidic compound and has a pH of from 6.0 to 8.5, is known (see, for example, JP-A No. 2011-68085).

### SUMMARY OF THE INVENTION

According to an aspect of the invention, an ink set which exhibits excellent maintenance property and excellent re-ejection property after maintenance, the ink set including an ink composition including resin particles including a polymer formed from one or more structural units selected from structural units, which are represented by the following Formula (1) and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group, a polymerizable compound having a (meth)acrylamido structure, water, a pigment, and a polymerization initiator; and a maintenance liquid including a compound having an SP value of from 8.00 (cal/cm³)^{1/2} to 12.00 (cal/cm³)^{1/2}, and an image forming method using the same are provided.

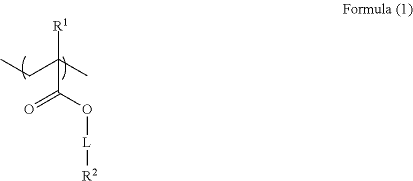

In Formula (1), R¹ represents a hydrogen atom or a methyl group; L represents a single bond or a divalent linking group; R² represents a hydrogen atom, a straight chain or branched alkyl group having 1 to 12 carbon atoms, an aryl group having 6 to 10 carbon atoms or an aralkyl group having 7 to 12 carbon atoms; and when R² represents a hydrogen atom, L represents a divalent linking group.

### TECHNICAL PROBLEM

However, in each of the above techniques, an aqueous curable ink, which contains a pigment, water, resin particles, a polymerizable compound having a (meth)acrylamido structure, and a polymerization initiator, has a tendency to be hardly removed even by using a liquid such as a maintenance liquid, when the ink is adhered (for example, adhered and solidified) to a member such as an inkjet head (namely, being inferior in maintenance property), and further, re-ejection property after maintenance by using a maintenance liquid tends to be easily deteriorated.

Accordingly, regarding the maintenance property and re-ejection property after maintenance by using a maintenance liquid, further improvement is needed for the aqueous curable ink.

The present invention has been made in view of the above circumstances and aims to accomplish the following.

Namely, an object of the invention is to provide an ink set which exhibits excellent maintenance property and excellent re-ejection property after maintenance.

Further, another object of the invention is to provide an image forming method which uses the ink set and with which images can be stably formed over a long time.

After diligently studying the problems, the present inventors have found that, with regard to an ink set including an aqueous curable ink containing a pigment, water, resin particles, a polymerizable compound having a (meth)acrylamido structure, and a polymerization initiator, and a maintenance liquid, the maintenance property and re-ejection property after maintenance can be improved by specifying the structure of a structural unit which constitutes a resin constituting the resin particles and, among the polymerizable compounds which are used for forming resin constituting the resin particles, specifying the SP value of a polymerizable compound other than the polymerizable compound that is used for forming a structural unit having an acidic group or a salt thereof, and specifying the SP value of a component contained in the maintenance liquid. Based on this finding, the present invention has been accomplished.

Namely, specific means to achieve the above objects are as follows.

<1> An ink set including an ink composition including resin particles including a polymer formed from one or more structural units selected from structural units, which are represented by the following Formula (1) and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group, a polymerizable compound having a (meth)acrylamido structure, water, a pigment, and a polymerization initiator; and a maintenance liquid including a compound having an SP value of from 8.00 (cal/cm³)^{1/2} to 12.00 (cal/cm³)^{1/2},

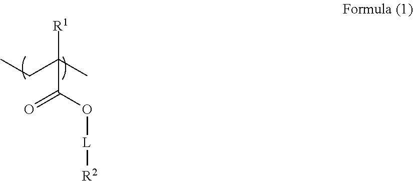

wherein, in Formula (1), R¹ represents a hydrogen atom or a methyl group; L represents a single bond or a divalent linking group; R² represents a hydrogen atom, a straight chain or branched alkyl group having 1 to 12 carbon atoms, an aryl group having 6 to 10 carbon atoms or an aralkyl group having 7 to 12 carbon atoms; and when R² represents a hydrogen atom, L represents a divalent linking group.

<2> The ink set according to the item <1>, wherein, in Formula (1), L represents a single bond or a group represented by —((CH₂)ₙO)ₘ—*; m and n each independently represent an integer of 1 or more; and * represents a bond position with R².

<3> The ink set according to the item <1> or the item <2>, wherein a glass transition temperature of the polymer that is comprised in the resin particles is less than 150° C.

<4> The ink set according to any one of the items <1> to <3>, wherein the resin particles are prepared by using a phase inversion emulsification method.

<5> The ink set according to any one of the items <1> to <4>, wherein a content of the one or more structural units which are represented by the Formula (1) and are derived from a polymerizable compound, having an SP value of from 8.80 (cal/cm³)^{1/2} to 14.00 (cal/cm³)^{1/2} is 80% by mass to 98% by mass, and a content of the one or more structural units selected from the group consisting of structural units having an acidic group and structural units having a salt of an acidic group is 2% by mass to 20% by mass, with respect to a total amount of the polymer that is comprised in the resin particles.

<6> The ink set according to any one of the items <1> to <5>, wherein the polymerizable compound having the (meth)acrylamido structure is a polyfunctional polymerizable compound represented by the following Formula (2):

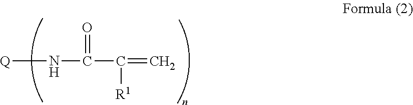

wherein, in Formula (2), Q represents n-valent linking group; R¹ represents a hydrogen atom or a methyl group; and n represents an integer from 2 to 6.

<7> The ink set according to the item <6>, wherein, in Formula (2), Q represents a residue group that is formed by eliminating two or more selected from hydrogen atom(s), hydroxyl group(s) or any combination thereof, from a polyol containing two or more oxyalkylene groups.

<8> The ink set according to any one of the items <1> to <7>, wherein the maintenance liquid further comprises an organic basic compound and an acidic compound.

<9> The ink set according to the item <8>, wherein a pKa value of a conjugate acid of the organic basic compound is in a range of from 6.0 to 8.5.

<10> The ink set according to the item <8> or the item <9>, wherein the acidic compound is at least one inorganic acid selected from the group consisting of hydrochloric acid, sulfuric acid, sulfurous acid, nitric acid and phosphoric acid.

<11> The ink set according to any one of the items <1> to <10>, further including a treatment liquid containing a coagulating agent capable of coagulating a component(s) in the ink composition.

<12> The ink set according to the item <11>, wherein the coagulating agent is at least one selected from the group consisting of an acidic compound, a multivalent metal salt and a cationic polymer.

<13> An image forming method using the ink set according to any one of the items <1> to <12>, the method including an ink applying process that applies the ink composition by discharging from an inkjet head onto a recording medium; and an ink removing process that removes the ink composition which has been adhered to the inkjet head by using the maintenance liquid.

<14> The image forming method according to the item <13>, further including a curing process that cures the ink composition by irradiating actinic energy ray to the ink composition that has been applied onto the recording medium.

<15> The image forming method according to the item <13> or the item <14>, further including a treatment liquid applying process that includes applying, onto the recording medium, a treatment liquid containing a coagulating agent capable of coagulating a component(s) in the ink composition.

<16> The image forming method according to the item <15>, wherein the ink applying process is performed after the treatment liquid applying process, and applies the ink composition onto the treatment liquid that has been applied onto the recording medium.

<17> The image forming method according to any one of the items <13> to <16>, wherein the recording medium is a coated paper which comprises base paper and a coated layer containing an inorganic pigment.

According to the present invention, an ink set which exhibits excellent maintenance property and excellent re-ejection property after maintenance may be provided.

Further, according to the present invention, an image forming method which uses the ink set and with which images can be stably formed over a long-term may be provided.

### BRIEF DESCRIPTION OF THE DRAWINGS

FIG. 1 is a schematic configuration diagram showing an example of the structure of an inkjet recording device for carrying out an image forming method of the present invention.

### DETAILED DESCRIPTION OF THE INVENTION

Hereinafter, an ink set of the invention, and an image forming method using the same will be described in detail.

<Ink Set>

The ink set of the present invention has at least one ink composition (hereinafter, may also be referred to as “ink”) containing resin particles including a polymer formed from one or more structural units selected from structural units, which are represented by Formula (1) described below and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group, a polymerizable compound having a (meth)acrylamido structure, water, a pigment, and a polymerization initiator; and at least one maintenance liquid containing a compound having an SP value of from 8.00 (cal/cm³)^{1/2} to 12.00 (cal/cm³)^{1/2}.

The term “maintenance” used in the present invention includes an operation for maintaining the inkjet head, that ejects the ink composition, and ejection performance thereof to be in the primary state or close to the primary state (conservation), and an operation of washing (cleaning) the inkjet head for the purpose of maintaining the inkjet head in a better state.

The term “maintenance property” used in the present invention indicates washability (removability) of an ink composition (for example, adhered and solidified substances of ink).

Further, the term “SP value” (solubility parameter, unit: (cal/cm³)^{1/2}) used in the present invention is a value calculated using the following equation according to the Fedors' method.

SP value (δ)=[ΣE_{coh}/ΣV]^{1/2}

Here, ΣE_{coh} represents the cohesive energy, and ΣV represents the molar molecular volume.

Details of the above “Fedors' method” are described in R. F. Fedors, “Polymer Engineering Science”, 14, pages 147 to 154 (1967), and the SP values in the invention are calculated by the method described in this literature.

In the ink set of the present invention, the SP value of the polymerizable compound for forming the structural unit represented by Formula (1) described below, among the polymerizable compounds for forming resin that constitutes the resin particles in the ink composition, is close to the Sp value of the compound in the maintenance liquid, and thus, the ink composition adhered (for example, adhered and solidified) to a member such as an inkjet head is easily removed by using the maintenance liquid (namely, the maintenance property is improved).

Further, the present inventors have found, after investigation, that the maintenance property (removability) is remarkably deteriorated when a cyclic alkyl group, such as a cyclohexyl group or an isobornyl group, is contained in the structural unit which constitutes the resin constituting the resin particles in the ink composition.

Therefore, the present inventors have found that, by specifying the structural unit of the resin constituting the resin particles to be within the range of not containing such a cyclic alkyl group, the maintenance property and the re-ejection property after maintenance are remarkably improved.

As described above, according to the ink set of the present invention, the maintenance property may be remarkably improved, and the re-ejection property after maintenance may be remarkably improved.

Hereinafter, constituent elements of the ink set of the present invention are described.

<<Ink Composition>>

The ink composition (ink) in the present invention contains resin particles (hereinafter, may also be referred to as “specific resin particles”) formed from a polymer including one or more structural units selected from structural units, which are represented by Formula (1) described below and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group; a polymerizable compound having a (meth)acrylamido structure; water; a pigment; and a polymerization initiator.

<Resin Particles>

The resin that constitutes the specific resin particles is formed from one or more structural units selected from structural units, which are represented by Formula (1) described below and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group.

Incorporation of the resin particles into the ink composition may result in improvement in strength of the image (for example, abrasion resistance or blocking resistance).

In the present invention, by using the specific resin particles as the resin particles, the maintenance property and re-ejection property after maintenance of the ink composition by using the “maintenance liquid containing a compound having an SP value of from 8.00 (cal/cm³)^{1/2} to 12.00 (cal/cm³)^{1/2}” are remarkably improved.

From the viewpoints of further improving the maintenance property and the re-ejection property after maintenance, the SP value of the polymerizable compound (the polymerizable compound for forming the resin constituting the resin particles) is preferably from 9.00 (cal/cm³)^{1/2} to 13.60 (cal/cm³)^{1/2}, and more preferably from 9.20 (cal/cm³)^{1/2} to 13.20 (cal/cm³)^{1/2}.

(Structural Unit Represented by Formula (1))

Next, Formula (1) is explained.

The resin that forms the specific resin particles contains one or more structural units represented by the following Formula (1).

The structural unit contributes to the improvement in the strength of the image (for example, abrasion resistance or blocking resistance).

Further, by specifying the SP value of the polymerizable compound for forming the above structural unit to be within the above range, the maintenance property and re-ejection property after maintenance of the ink composition, by using the maintenance liquid described below, are remarkably improved.

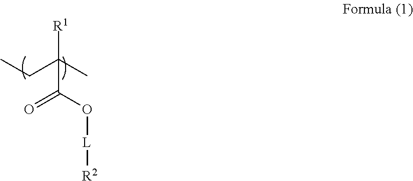

In Formula (1), R¹ represents a hydrogen atom or a methyl group. L represents a single bond or a divalent linking group. R² represents a hydrogen atom, a straight chain or branched alkyl group having from 1 to 12 carbon atoms, an aryl group having from 6 to 10 carbon atoms, or an aralkyl group having from 7 to 12 carbon atoms. However, when R² represents a hydrogen atom, L represents a divalent linking group.

The divalent linking group represented by L is not particularly limited, and examples include a group represented by —((CH₂)ₙO)ₘ—* (n and m each independently represent an integer of one or more, and the symbol “*” denotes the bonding position with R²), and an alkylene group.

L preferably represents a single bond or a group represented by —((CH₂)ₙO)ₘ—* (n and m each independently represent an integer of one or more, and the symbol “*” denotes the bonding position with R²), which is a divalent linking group.

In “—((CH₂)ₙO)ₘ—*” above, n preferably represents an integer of from 1 to 12, more preferably an integer of from 1 to 6, even more preferably 1 or 2, and most preferably 2.

In “—((CH₂)ₙO)ₘ—*” above, m preferably represents an integer of from 1 to 200, and more preferably an integer of from 1 to 100.

Examples of the straight chain or branched alkyl group which has from 1 to 12 carbon atoms and is represented by R² include a methyl group, an ethyl group, a propyl group (an n-propyl group, or an i-propyl group), a butyl group (an n-butyl group, an s-butyl group, or a t-butyl group), a pentyl group, a hexyl group, a heptyl group, an octyl group, a nonyl group, a decyl group, a undecyl group, and a dodecyl group.

The straight chain or branched alkyl group represented by R² preferably has from 1 to 6 carbon atoms.

Examples of the aryl group which has from 6 to 10 carbon atoms and is represented by R² include a phenyl group and a naphthyl group.

Examples of the aralkyl group which has from 7 to 12 carbon atoms and is represented by R² include a benzyl group and a phenethyl group.

The structural unit represented by Formula (1) above is a structural unit derived from a polymerizable compound (hereinafter, may also be referred to as a “specific monomer”) having an SP value of from 8.80 (cal/cm³)^{1/2} to 14.00 (cal/cm³)^{1/2}.

A monomer having an SP value within the above range may be selected from the monomers exemplified below and used as the specific monomer.

Namely, examples of the monomer, which can be used as the specific monomer, include an alkyl ester of (meth)acrylic acid in which the alkyl moiety has from 1 to 12 carbon atoms, a hydroxyalkyl ester of (meth)acrylic acid in which the hydroxyalkyl moiety has from 1 to 12 carbon atoms, an alkoxy ester of (meth)acrylic acid in which the alkoxy moiety has from 1 to 12 carbon atoms, (meth)acrylate containing an aryl group having from 6 to 10 carbon atoms, (meth)acrylate containing an aralkyl group having from 7 to 12 carbon atoms, and polyalkylene glycol (meth)acrylate.

In the present invention, the term “(meth)acrylic acid” means acrylic acid or methacrylic acid, and the term “(meth)acrylate” means acrylate or methacrylate.

Specific examples of the specific monomer are shown below together with the SP value, but the present invention is not limited to the specific examples. In the following specific examples, the numeric value in the parentheses represents the SP value (unit: (cal/cm³)^{1/2}).

Examples of the alkyl ester of (meth)acrylic acid in which the alkyl moiety has from 1 to 12 carbon atoms include methyl methacrylate (9.34), butyl methacrylate (9.09), and dodecyl methacrylate (8.84).

Examples of the hydroxyalkyl ester of (meth)acrylic acid in which the hydroxyalkyl moiety has from 1 to 12 carbon atoms include hydroxyethyl acrylate (13.05) and 2-hydroxypropyl acrylate (12.32).

Examples of the alkoxy ester of (meth)acrylic acid in which the alkoxy moiety has from 1 to 12 carbon atoms include methoxyethyl acrylate (9.41) and methoxyethyl methacrylate (9.34).

Examples of the (meth)acrylate containing an aryl group having from 6 to 10 carbon atoms include phenoxyethyl acrylate (10.41) and phenoxyethyl methacrylate (10.29).

Examples of the (meth)acrylate containing an aralkyl group having from 7 to 12 carbon atoms include benzyl methacrylate (10.33) and phenethyl methacrylate (10.17).

Examples of the polyalkylene glycol (meth)acrylate include polyethylene glycol acrylate (in which the number of the repeated structural units derived from ethylene glycol is 100) (9.48), and polyethylene glycol acrylate (in which the number of the repeated structural units derived from ethylene glycol is 200) (9.42).

The resin that forms the specific resin particles may contain one kind of the structural units represented by Formula (1) above, or may contain two or more kinds of them.

From the viewpoint of more effectively realizing the effect of the invention, the resin that forms the specific resin particles preferably contains a structural unit which is a structural unit represented by Formula (1) above, in which R² represents an aryl group having from 6 to 10 carbon atoms or an aralkyl group having from 7 to 12 carbon atoms, and a structural unit which is a structural unit represented by Formula (1) above, in which R² represents a straight chain or branched alkyl group having from 1 to 12 carbon atoms.

(Structural Units Having an Acidic Group and Structural Units Having a Salt of an Acidic Group)

The resin that forms the specific resin particles has one or more structural units selected from the group consisting of structural units having an acidic group and structural units having a salt of an acidic group. The structural unit contributes to the progress of dispersion of the whole resin particles and dispersion stability.

The structural unit having an acidic group is formed, for example, through polymerization of a polymerizable compound having an acidic group.

The structural unit having a salt of an acidic group may be a structural unit obtained by neutralizing a structural unit having an acidic group (details on neutralization are described below), or may be a structural unit formed through polymerization of a polymerizable compound having a salt of an acidic group.

There is no particular limitation as to the SP value of the polymerizable compound having an acidic group and the SP value of the polymerizable compound having a salt of an acidic group.

The acidic group includes a carboxyl group, a sulfonic acid group, a phosphoric acid group and the like. The polymerizable compound having an acidic group may be, for example, an unsaturated carboxylic acid monomer, an unsaturated sulfonic acid monomer, or an unsaturated phosphoric acid monomer.

Specific examples of the unsaturated carboxylic acid monomer include (meth)acrylic acid, crotonic acid, itaconic acid, maleic acid, fumaric acid, citraconic acid, and 2-methacryloyloxymethylsuccinic acid.

Specific examples of the unsaturated sulfonic acid monomer include styrenesulfonic acid, 2-acrylamide-2-methylpropane sulfonic acid, 3-sulfopropyl (meth)acrylate, and bis-(3-sulfopropyl) itaconate.

Examples of the unsaturated phosphoric acid monomer include vinyl phosphonic acid, vinyl phosphate, bis(methacryloyloxyethyl) phosphate, diphenyl-2-acryloyloxyethyl phosphate, diphenyl-2-methacryloyloxyethyl phosphate, and dibutyl-2-acryloyloxyethyl phosphate.

Among the above polymerizable compounds having the acidic group, unsaturated carboxylic acid monomers are preferable, acrylic type monomers are more preferable, and (meth)acrylic acids are still more preferable, in consideration of dispersion stability and ejection stability.

Examples of the salt of an acidic group include alkali metal salts (a K salt, an Na salt, an Li salt, and the like) of a carboxyl group, a sulfonic acid group, or a phosphoric acid group. Among the above, alkali metal salts (a K salt, an Na salt, an Li salt, and the like) of a carboxyl group are preferable.

Examples of the polymerizable compound having a salt of an acidic group include alkali metal salts (a K salt, an Na salt, an Li salt, and the like) of a polymerizable compound having an acidic group exemplified above. Above all, alkali metal salts (a K salt, an Na salt, an Li salt, and the like) of (meth)acrylic acid are preferable.

The resin that forms the specific resin particles may contain one kind of the structural units selected from the group consisting of structural units having an acidic group and structural units having a salt of an acidic group, or may contain two or more kinds of them.

From the viewpoint of dispersion stability, the resin that forms the specific resin particles preferably contains a structural unit having an acidic group and a structural unit having a salt of an acidic group.

In particular, in the specific resin particles, the ratio of [(number of salts of acidic groups/(number of acidic groups+number of salts of acidic groups)] is preferably from 0.5 to 0.9, more preferably from 0.6 to 0.9, and particularly preferably from 0.7 to 0.9, from the viewpoint of the dispersion stability in a case in which the ink composition contains a polymerizable compound.

The specific resin particles including the resin which includes the structural unit having an acidic group and the structural unit having a salt of an acidic group can be produced by, for example, preparing resin particles from a resin that contains a structural unit having an acidic group but does not contain a structural unit having a salt of an acidic group, and subsequently neutralizing the acidic group of the resin particles. In this case, the ratio corresponds to the neutralization degree.

The copolymerization ratio in the resin that forms the specific resin particles is not particularly limited, but it is preferable that the content of the “one or more structural units selected from structural units which are represented by Formula (1) and are derived from a polymerizable compound having an SP value of from 8.80 (cal/cm³)^{1/2} to 14.00 (cal/cm³)^{1/2}” is from 80% by mass to 98% by mass (more preferably from 85% by mass to 97% by mass), and the content of the “one or more structural units selected from the group consisting of structural units having an acidic group and structural units having a salt of an acidic group” is from 2% by mass to 20% by mass (more preferably from 3% by mass to 15% by mass), with respect to the total mass of resin that forms the specific resin particles. Here, the total of the content of the whole structural units is 100% by mass.

When the copolymerization ratio is as described above, the maintenance property and re-ejection property after maintenance of the ink composition, by using the maintenance liquid described below, are remarkably improved.

Further, it is preferable that the specific resin particles have a function of fixing the ink composition, namely, the image, by causing formation of an aggregate or unstablizing the dispersion to thicken the ink when the ink is brought into contact with the treatment liquid described below or with a paper region onto which the treatment liquid is applied and dried.

In a preferred mode (for example, a form of latex), the specific resin particles in the ink composition are dispersed in at least one of water or an organic solvent.

As the resin that forms the specific resin particles, an acryl-based resin, a vinyl acetate based resin, a styrene-butadiene based resin, a vinyl chloride based resin, an acryl-styrene based resin, a butadiene based resin, a styrene based resin, a crosslinked acrylic resin, a crosslinked styrene based resin, a benzoguanamine resin, a phenol resin, a silicone resin, an epoxy resin, a urethane based resin, a paraffin based resin, a fluorine based resin, or the like, or a latex thereof may be used. Preferable examples may include an acryl-based resin, an acryl-styrene based resin, a styrene based resin, a crosslinked acrylic resin, and a crosslinked styrene based resin.

The weight average molecular weight of the resin that forms the specific resin particles is preferably from 10,000 to 200,000, and more preferably from 20,000 to 200,000.

Further, the volume average particle diameter of the specific resin particles is preferably in a range of from 1 nm to 1 μm, more preferably in a range of from 1 nm to 200 nm, even more preferably in a range of from 1 nm to 100 nm, and particularly preferably in a range of from 1 nm to 50 nm.

The volume average particle diameter of the specific resin particles can be measured using a NANOTRACK particle size distribution analyzer UPA-EX150 (trade name, manufactured by Nikkiso Co., Ltd.).

The weight average molecular weight is measured with a gel permeation chromatography (GPC). As a GPC instrument, HLC-8220GPC manufactured by Tosoh Corporation, is used; the columns (three in number) to be used are TSKgel Super HZM-H, TSKgel SuperHZ4000, and TSKgel SuperHZ2000 (all manufactured by Tosoh Corporation, 4.6 mmID×15 cm); and THF (tetrahydrofuran) is used as an eluent. Further measurement conditions are set as follows.

Sample concentration: 0.35% by mass
Flow rate: 0.35 ml/min
Injected amount of sample: 10 μL
Measuring temperature: 40° C.
Measurement is conducted using an RI (Refractive Index) detector.
The calibration curve is prepared from 8 samples of “Standard sample TSK standard, polystyrene”: “F-40”, “F-20”, “F-4”, “F-1”, “A-5000”, “A-2500”, “A-1000” and “n-PROPYL BENZENE” (all trade names, manufactured TOSHO CORPORATION).

The glass transition temperature (Tg) of the polymer that forms the specific resin particles is preferably lower than 150° C. When the glass transition temperature (Tg) of the polymer that forms the specific resin particles is lower than 150° C., the maintenance property may be further improved.

There is no particular limitation as to the lower limit of the glass transition temperature (Tg), but the lower limit is preferably 30° C., more preferably 40° C., and even more preferably 50° C.

The glass transition temperature (Tg) of the polymer that forms the specific resin particles can be controlled as appropriate by generally-used methods. For example, the glass transition temperature (Tg) of the polymer that forms the specific resin particles can be controlled in a desired range by selecting as appropriate the type of the polymerizable group of the monomer (polymerizable compound) that forms the specific resin particles, the type or the constituent ratio of the substituent on the monomer, the molecular weight of the polymer molecule that forms the specific resin particles, or the like.

For the glass transition temperature (Tg) of the polymer that forms the specific resin particles, a measured Tg obtained by actual measurement is applied.

Specifically, the measured Tg means a value measured under usual measurement conditions using a differential scanning calorimeter (DSC) EXSTAR6220 (trade name) manufactured by SII Nanotechnology Inc. However, in a case in which the measurement is difficult due to degradation of the resin or the like, a calculated Tg obtained by calculation according to the following calculation formula is applied. The calculated Tg is obtained by calculation according to the following Equation (1).

1/Tg=Σ(Xᵢ/Tgᵢ) (1)

Here, a polymer as a calculation target is assumed that n kinds of monomer components of i=1 to n are copolymerized. Xᵢ represents the weight fraction (ΣXᵢ=1) of the i-th monomer, and Tgᵢ represents the glass transition temperature (absolute temperature) of a homopolymer of the i-th monomer. E represents the sum of i=1 to n. As the value (Tgᵢ) of the glass transition temperature of a homopolymer of each monomer, the values described in “Polymer Handbook” (3rd Edition) (written by J. Brandrup and E. H. Immergut (Wiley-Interscience, 1989)) are employed.

The content of the specific resin particles is preferably from 0.1% by mass to 20% by mass, more preferably from 0.1% by mass to 15% by mass, and even more preferably from 0.1% by mass to 10% by mass.

There is no particular limitation as to the particle size distribution of the specific resin particles. The specific resin particles may have either a broad particle size distribution or a mono-dispersed particle size distribution. Two or more kinds of resin particles, each of which having a mono-dispersed particle size distribution, may be used in combination as a mixture.

The specific resin particles are preferably resin particles obtained by a phase inversion emulsification method, and more preferably particles of a self-dispersing resin (self-dispersing resin particles) described below.

Here, the term “self-dispersing resin” refers to a water-insoluble polymer that, when dispersed by a phase inversion emulsification method, can get into a dispersed state in an aqueous medium, in the absence of a surfactant, due to functional groups (particularly, acid groups or salts thereof) of the polymer itself.

The scope of the term “dispersed state” used herein includes both an emulsified state (emulsion) in which a water-insoluble polymer in the liquid state is dispersed in an aqueous medium and a dispersed state (suspension) in which a water-insoluble polymer in the solid state is dispersed in an aqueous medium.

Further, the term “water-insoluble” means that the amount of dissolution is 5.0 parts by mass or less with respect to 100 parts by mass of water (at 25° C.).

As the self-dispersing resin particles, those selected from the self-dispersing resin particles described in paragraphs 0090 to 0121 of JP-A No. 2010-64480 and paragraphs 0130 to 0167 of JP-A No. 2011-068085 can be used.

The molecular weight of the water-insoluble polymer that forms the self-dispersing resin particles, in terms of weight average molecular weight, is preferably from 3,000 to 200,000, and more preferably from 5,000 to 150,000, and even more preferably from 10,000 to 100,000. When the weight average molecular weight is 3,000 or more, the amount of water-soluble components can be effectively reduced. Further, when the weight average molecular weight is 200,000 or less, the self-dispersion stability can be enhanced.

The resin that forms the specific resin particles in the invention (for example, the water-insoluble polymer that forms the self-dispersing resin particles) preferably includes at least one of a constituent unit derived from (meth)acrylate containing an aryl group having from 6 to 10 carbon atoms or a constituent unit derived from (meth)acrylate containing an aralkyl group having from 7 to 12 carbon atoms, a constituent unit derived from (meth)acrylic acid, and a constituent unit derived from an alkyl ester of (meth)acrylic acid in which the alkyl moiety has from 1 to 12 carbon atoms (preferably, from 1 to 4 carbon atoms).

Further, from the viewpoint of the control of hydrophilicity and hydrophobicity of the polymer, the resin that forms the specific resin particles preferably includes at least one of a constituent unit derived from (meth)acrylate containing an aryl group having from 6 to 10 carbon atoms or a constituent unit derived from (meth)acrylate containing an aralkyl group having from 7 to 12 carbon atoms at a copolymerization ratio of from 15% by mass to 80% by mass, a constituent unit derived from (meth)acrylic acid, and a constituent unit derived from an alkyl ester of (meth)acrylic acid in which the alkyl moiety has from 1 to 12 carbon atoms (preferably, from 1 to 4 carbon atoms).

Above all, it is more preferable that the resin that forms the specific resin particles includes at least one of a constituent unit derived from phenoxyethyl (meth)acrylate or a constituent unit derived from benzyl (meth)acrylate at a copolymerization ratio of from 15% by mass to 80% by mass, a constituent unit derived from (meth)acrylic acid, and a constituent unit derived from an alkyl ester of (meth)acrylic acid in which the alkyl moiety has from 1 to 12 carbon atoms (preferably, from 1 to 4 carbon atoms).

Furthermore, in addition to these preferable modes, the resin that forms the specific resin particles preferably has an acid value of from 25 to 100 and a weight average molecular weight of from 3,000 to 200,000, and more preferably an acid value of from 25 to 95 and a weight average molecular weight of from 5,000 to 150,000.

Moreover, in the resin according to the preferable mode described above, at least a part of the whole carboxyl groups may be a salt of a carboxyl group (for example, an alkali metal salt) obtained by neutralization.

Specific examples of the resin that forms the specific resin particles (for example, the water-insoluble resin that forms the self-dispersing resin particles) include the following resins. However, the present invention is not limited to these specific examples. The numeric values in the parentheses represent the mass ratio of copolymerization components. In the following specific examples, at least a part of the whole carboxyl groups may be a salt of a carboxyl group (for example, an alkali metal salt) obtained by neutralization.
benzyl methacrylate/methyl methacrylate/methacrylic acid copolymer (50/44/6)
phenoxyethyl acrylate/methyl methacrylate/acrylic acid copolymer (50/45/5)
methyl methacrylate/butyl methacrylate/methacrylic acid copolymer (80/10/10)
methyl methacrylate/methacrylic acid/acrylic acid copolymer (88/6/6)
methoxyethyl acrylate/methyl methacrylate/methacrylic acid copolymer (50/40/10)
hydroxyethyl acrylate/methyl methacrylate/methacrylic acid copolymer (50/40/10)
dodecyl methacrylate/methyl methacrylate/methacrylic acid copolymer (10/80/10)
polyethylene glycol acrylate/methyl methacrylate/methacrylic acid copolymer (10/80/10)
phenoxyethyl acrylate/benzyl methacrylate/isobutyl methacrylate/methacrylic acid copolymer (30/35/29/6)
phenoxyethyl methacrylate/isobutyl methacrylate/methacrylic acid copolymer (50/44/6)
phenoxyethyl acrylate/methyl methacrylate/ethyl acrylate/acrylic acid copolymer (30/55/10/5)
benzyl methacrylate/isobutyl methacrylate/methacrylic acid copolymer (35/59/6)
benzyl acrylate/methyl methacrylate/acrylic acid copolymer (55/40/5)
phenoxyethyl methacrylate/benzyl acrylate/methacrylic acid copolymer (45/47/8)
phenoxyethyl acrylate/methyl methacrylate/butyl acrylate/methacrylic acid copolymer (12/50/30/8)
benzyl acrylate/isobutyl methacrylate/acrylic acid copolymer (93/2/5)
methyl methacrylate/phenoxyethyl acrylate/acrylic acid copolymer (45/51/4)
methyl methacrylate/phenoxyethyl acrylate/acrylic acid copolymer (45/49/6)
methyl methacrylate/phenoxyethyl acrylate/acrylic acid copolymer (45/48/7)
methyl methacrylate/phenoxyethyl acrylate/acrylic acid copolymer (45/47/8)
methyl methacrylate/phenoxyethyl acrylate/acrylic acid copolymer (45/45/10)

The method of producing the water-insoluble polymer forming the self-dispersing resin particles in the present invention is not particularly limited, and may be a method including performing emulsion polymerization in the presence of a polymerizable surfactant so as to covalently bond the surfactant to the water-insoluble polymer or a method including copolymerizing a monomer mixture containing a hydrophilic-group-containing monomer and an aromatic-group-containing monomer by a known polymerization process such as a solution polymerization method or a bulk polymerization method. Among the above polymerization methods, a solution polymerization is preferable, and a solution polymerization method using an organic solvent is more preferable, in consideration of aggregation speed and jetting stability of an ink composition containing the self-dispersing polymer particles.

From the viewpoint of the aggregation speed, it is preferable that the self-dispersing resin particles include a polymer (in some cases, it is also referred as a first polymer) synthesized in an organic solvent, and the first polymer has carboxyl groups (and preferably has an acid value of from 25 to 100), in which at least a portion of the carboxyl groups of the first polymer is neutralized and the first polymer is prepared in the form of a polymer dispersion having a continuous phase of water.

That is, the method of producing the self-dispersing resin particle preferably includes a process of synthesizing the first polymer in an organic solvent and a dispersion process of forming an aqueous dispersion in which at least a portion of the carboxyl groups of the first polymer is neutralized.

In this case, the neutralization degree is preferably from 0.5 to 0.9, more preferably from 0.6 to 0.9, and particularly preferably from 0.7 to 0.9.

Here, the “neutralization degree” indicates a ratio of [number of neutralized carboxyl groups/total number of carboxyl groups before neutralization]. In other words, the neutralization degree is defined as a ratio of [number of salts of carboxyl groups/(number of carboxyl groups+number of salts of carboxyl groups)] after neutralization.

The dispersion process preferably includes the following Processes (1) and (2):

Process (1): a process of stirring a mixture containing a first polymer (water-insoluble polymer), an organic solvent, a neutralizing agent, and an aqueous medium

Process (2): a process of removing the organic solvent from the mixture

The process (1) is preferably a process in which the first polymer (water-insoluble polymer) is dissolved in the organic solvent, and then the neutralizing agent and the aqueous medium are gradually added to the polymer solution and mixed, by stirring, with the polymer solution to form a dispersion. When the neutralizing agent and the aqueous medium are added to the water-insoluble polymer solution in which the water-insoluble polymer is dissolved in the organic solvent as in the above process, self-dispersing resin particles whose diameter is highly stable during storage can be obtained without requiring a strong shearing force.

The method of stirring the mixture is not particularly limited, and may be a method using a generally-used mixing and stirring apparatus and/or, if necessary, a disperser such as an ultrasonic disperser or a high-pressure homogenizer.

Preferable examples of the organic solvent described above include an alcohol solvent, a ketone solvent, and an ether solvent.

Examples of the alcohol solvent include isopropyl alcohol, n-butanol, t-butanol, and ethanol. Examples of the ketone solvent include acetone, methyl ethyl ketone, diethyl ketone, and methyl isobutyl ketone. Examples of the ether solvent include dibutyl ether and dioxane. Among the above solvents, ketone solvents such as methyl ethyl ketone and alcohol solvents such as isopropyl alcohol are preferable. It is also preferable to use isopropyl alcohol and methyl ethyl ketone together for the purpose of making the polarity change milder at the time of phase inversion from an oil phase to an aqueous phase. The combination of these solvents makes it possible to obtain self-dispersing resin particles having a very small particle diameter that are free from aggregation precipitation or adhesion between the particles and that have high dispersion stability.

The neutralizing agent is used to neutralize all or some of the acid groups (for example, a carboxyl group or the like) of the polymer so as to allow the self-dispersing resin to get into a stable emulsion or dispersion state in water. The neutralizing agent to be used may be a basic compound such as an organic amine compound, ammonia, or an alkali metal hydroxide. Examples of the organic amine compound include monomethylamine, dimethylamine, trimethylamine, monoethylamine, diethylamine, triethylamine, monopropylamine, dipropylamine, monoethanolamine, diethanolamine, triethanolamine, N,N-dimethyl-ethanolamine, N,N-diethyl-ethanolamine, 2-dimethylamino-2-methyl-1-propanol, 2-amino-2-methyl-1-propanol, N-methyldiethanolamine, N-ethyldiethanolamine, monoisopropanolamine, diisopropanolamine, and triisopropanolamine. Examples of the alkali metal hydroxide include lithium hydroxide, sodium hydroxide, and potassium hydroxide. Among them, sodium hydroxide, potassium hydroxide, triethylamine, and triethanolamine are preferable from the viewpoint of dispersion stability in water of the self-dispersing resin particles.

The amount of the basic compound to be used is preferably from 5% by mol to 120% by mol, more preferably from 10% by mol to 110% by mol, and even more preferably from 15% by mol to 100% by mol, with respect to 100% by mol of the acid group. When the amount of the basic compound is 15% by mol or more, an effect of stabilizing the dispersion of the particles in water can be especially enhanced. When the amount of the basic compound is 100% by mol or less, an effect of decreasing the amount of the water-soluble component can be obtained.

In the process (2), the organic solvent is removed, by distillation, from the dispersion obtained in the process (1) using a common method such as distillation under reduced pressure, whereby phase inversion into an aqueous system occurs and an aqueous dispersion of the self-dispersing resin particles is obtained. The organic solvent has substantially been removed from the obtained aqueous dispersion, and the amount of the remaining organic solvent is preferably 0.2% by mass or less, and more preferably 0.1% by mass or less.

The volume average particle size of the self-dispersing resin particles in the invention is preferably in the range of from 10 nm to 400 nm, more preferably from 10 nm to 200 nm, and even more preferably from 10 nm to 100 nm. When the volume average particle size is 10 nm or more, the suitability of production is improved. When the volume average particle size is 400 nm or less, preservation stability is improved.

The particle size distribution of the self-dispersing resin particles is not particularly limited, and the self-dispersing resin particles may have a broad particle size distribution or a mono-dispersed particle size distribution. It is possible to use a mixture of two or more types of water-insoluble particles.

The average particle diameter and particle size distribution of the self-dispersing resin particles is obtained by measuring the volume average particle diameters of the particles by a dynamic light scattering method.

The self-dispersing resin particles may be preferably contained in the ink composition of the present invention. It is possible to use a mixture of two or more types of self-dispersing resin particles.

<Polymerizable Compound Having a (meth)acrylamido Structure>

The ink composition in the present invention contains at least one polymerizable compound having a (meth)acrylamido structure.

The term “(meth)acrylamide” used herein means acrylamide or methacrylamide.

Incorporation of the polymerizable compound having a (meth)acrylamido structure into the ink composition in the present invention may result in improvement in stability during thermal aging of the ink composition, as compared with the case of not containing the polymerizable compound (for example, the case of using a polymerizable compound that does not have a (meth)acrylamido structure).

Further, incorporation of the polymerizable compound having a (meth)acrylamido structure into the ink composition in the present invention may result in obtaining an effect of improving curing sensitivity, as compared with the case of not containing the polymerizable compound (for example, the case of using a polymerizable compound that does not have a (meth)acrylamido structure).

It is preferable that the polymerizable compound having a (meth)acrylamido structure is a compound that causes polymerization when irradiated with an actinic energy ray (for example, radiation, light, electron beam, or the like).

The polymerizable compound having a (meth)acrylamido structure is not particularly limited, but it is preferably a water soluble compound. Here, the term “water soluble” used in the polymerizable compound means that the compound can be dissolved in water at a certain concentration or more, and it is enough that the compound can be dissolved in an aqueous ink (desirably, homogenously). Further, the water soluble compound may be a compound which dissolves in ink (desirably, homogenously), by the addition of a water soluble organic solvent described below, which raises the solubility of the compound. Specifically, the degree of solubility with respect to water at 25° C. is preferably 5% by mass or more, and more preferably 10% by mass or more.

As the polymerizable compound having a (meth)acrylamido structure, a monofunctional polymerizable compound having a (meth)acrylamido structure may be used, or a polyfunctional polymerizable compound having a (meth)acrylamido structure may be used, or these compounds may be used in combination.

Examples of the monofunctional polymerizable compound having a (meth)acrylamido structure include hydroxyethyl (meth)acrylamide, hydroxypropyl (meth)acrylamide, dimethylaminoethyl (meth)acrylamide, and dimethylaminopropyl (meth)acrylamide. Among the above, hydroxyethyl (meth)acrylamide is particularly preferable, and hydroxyethyl acrylamide is most preferable.

Example of the polyfunctional polymerizable compound having a (meth)acrylamido structure include compounds represented by Formula (2) described below.

From the viewpoint of improvement in curing sensitivity, the polymerizable compound having a (meth)acrylamido structure according to the present invention preferably includes a polyfunctional polymerizable compound having a (meth)acrylamido structure, and more preferably includes a compound represented by the following Formula (2).

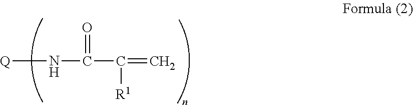

In Formula (2), Q represents a linking group having a valency of n, and R¹ represents a hydrogen atom or a methyl group. Further, n represents an integer of 2 or more.

The compound represented by Formula (2) is a compound in which unsaturated monomers are bonded to the linking group Q through an amido bond.

R¹ represents a hydrogen atom or a methyl group, and preferably represents a hydrogen atom.

There is no limitation as to the valence number n of the linking group Q, but from the viewpoint of improving polymerization efficiency and ejection stability, n is preferably from 2 to 6, and more preferably from 2 to 4.

Further, the linking group Q is not particularly limited as far as the group is capable of linking with a (meth)acrylamido structure, but is preferably selected from linking groups with which the compound represented by Formula (2) satisfies the above-described solubility with respect to water. Specifically, examples thereof include residues obtained by removing two or more selected from hydrogen atom(s), hydroxyl group(s) or any combination thereof, from the compound in the following compound group X.

—Compound Group X—

Polyols such as ethylene glycol, diethylene glycol, triethylene glycol, polyethylene glycol, propylene glycol, dipropylene glycol, tripropylene glycol, polypropylene glycol, 1,3-propane diol, 1,2-butanediol, 1,3-butanediol, 1,4-butanediol, 2,3-butanediol, 1,5-pentanediol, 1,4-pentanediol, 2,4-pentanediol, 3-methyl-1,5-pentanediol, 2-methyl-2,4-pentanediol, 1,5-hexanediol, 1,6-hexanediol, 2,5-hexanediol, glycerin, 1,2,4-butane triol, 1,2,6-hexane triol, 1,2,5-pentane triol, thioglycol, trimethylol propane, ditrimethylol propane, trimethylol ethane, ditrimethylol ethane, neopentyl glycol, pentaerythritol, dipentaerythritol and their condensates, low molecular weight polyvinyl alcohol, or sugars, polyamines such as ethylenediamine, diethylenetriamine, triethylenetetramine, polyethyleneimine and polypropylenediamine.

In addition, examples may include substituted or unsubstituted alkylene chains having 4 or less carbon atoms, such as a methylene group, an ethylene group, a propylene group, or a butylene group, and further, functional groups having a saturated or unsaturated heterocyclic ring such as a pyridine ring, an imidazole ring, a pyrazine ring, a piperidine ring, a piperazine ring, or a morpholine ring.

The linking group Q is preferably a linking group containing an oxyalkylene group (preferably, an oxyethylene group), from the viewpoint of solubility with respect to water. Above all, the linking group Q is more preferably a linking group containing two or more oxyalkylene groups (preferably, oxyethylene groups), and even more preferably a linking group containing three or more oxyalkylene groups (preferably, oxyethylene groups).

In a particularly preferable mode, the linking group Q is a residue of a polyol containing one or more (preferably two or more, and more preferably three or more) oxyalkylene groups (preferably, oxyethylene groups).

Specific examples of the polymerizable compound represented by Formula (2) above may include the following polymerizable compounds.

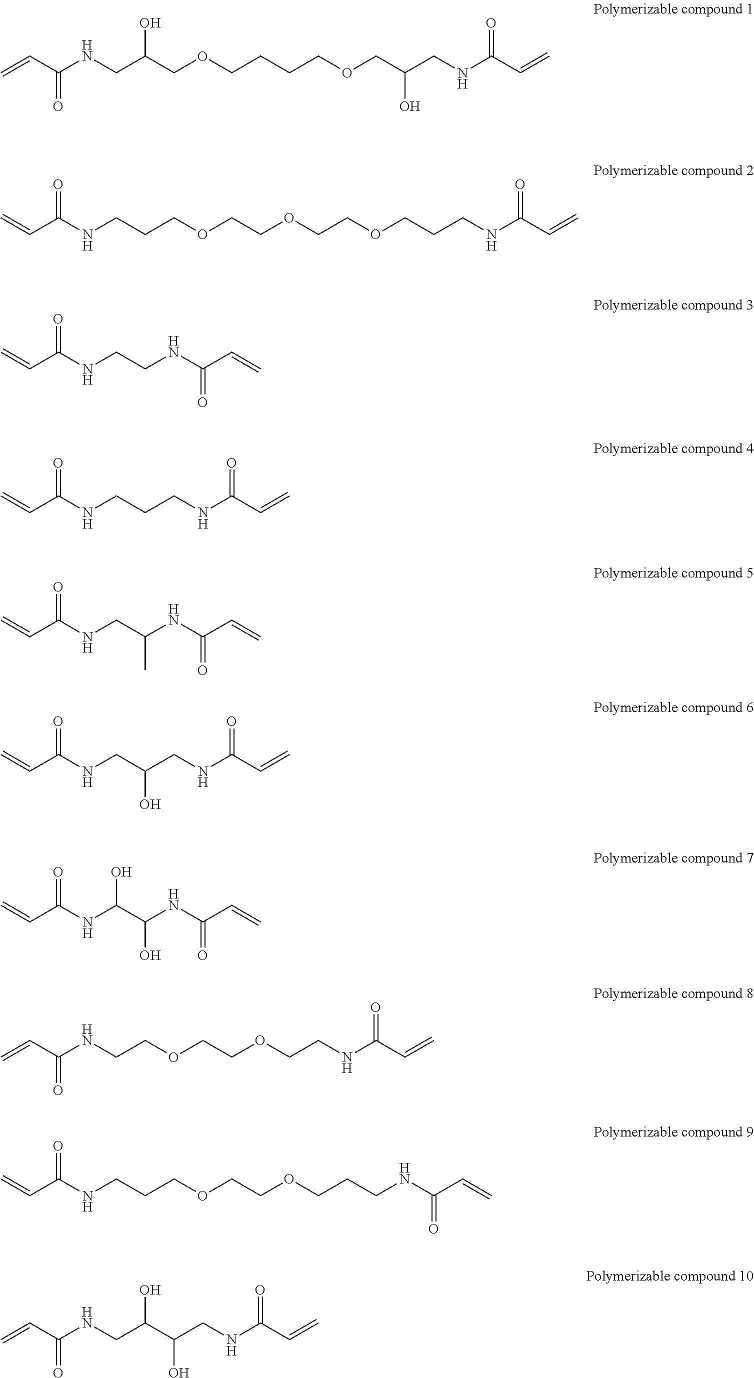

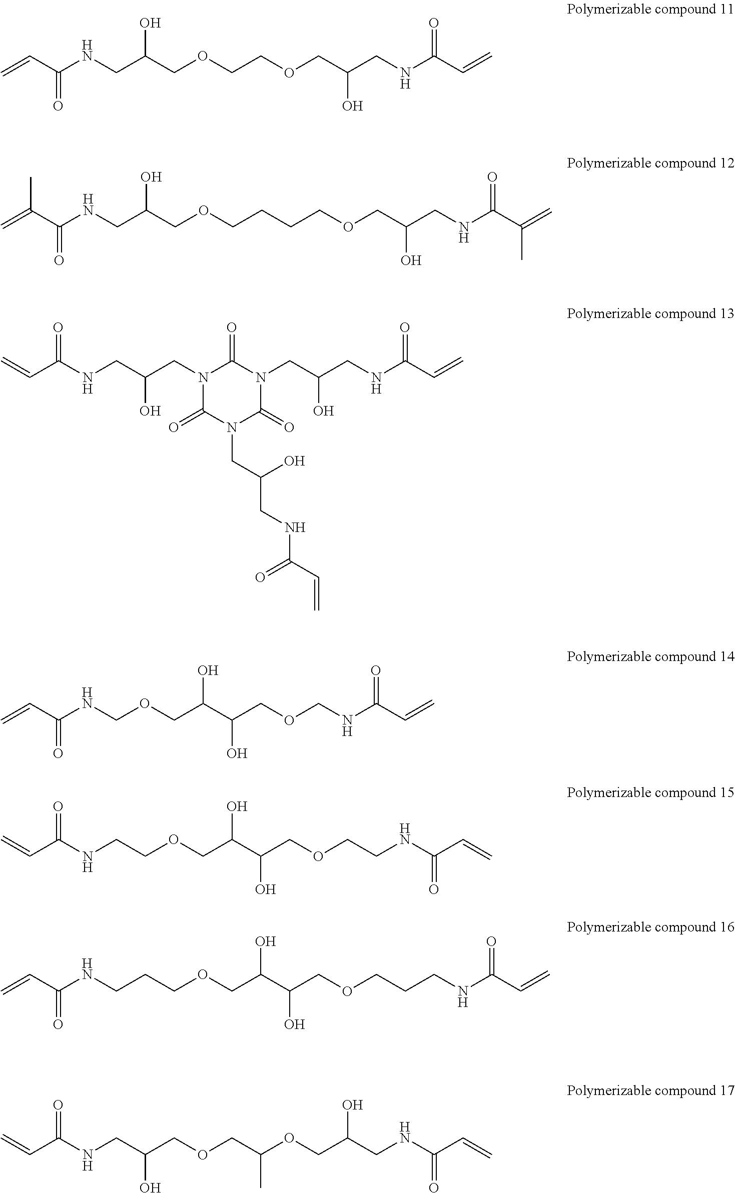

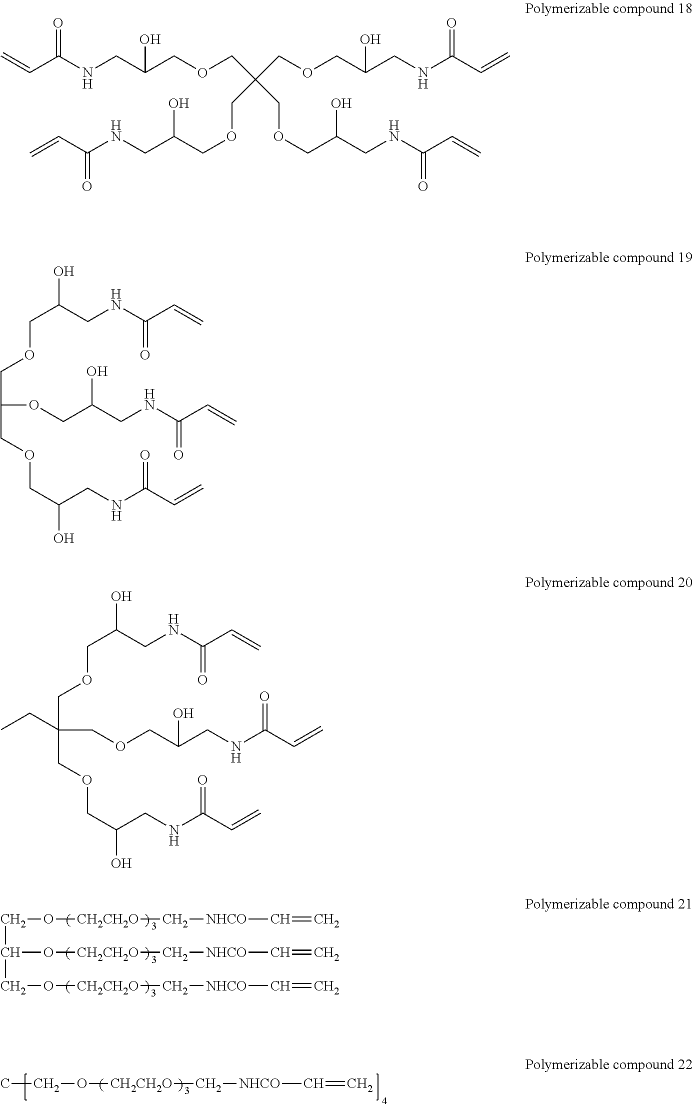

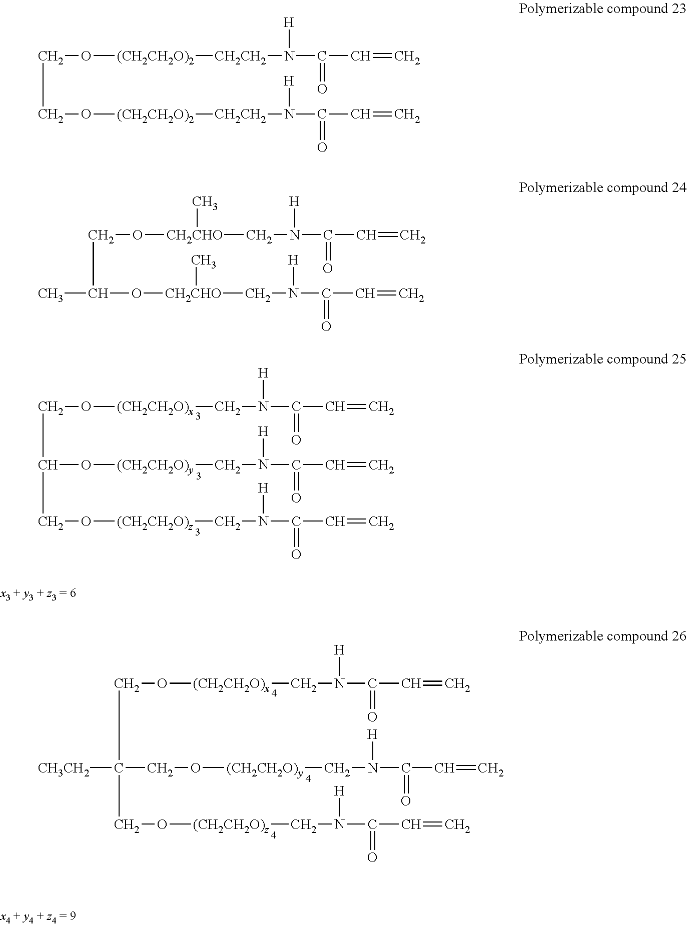

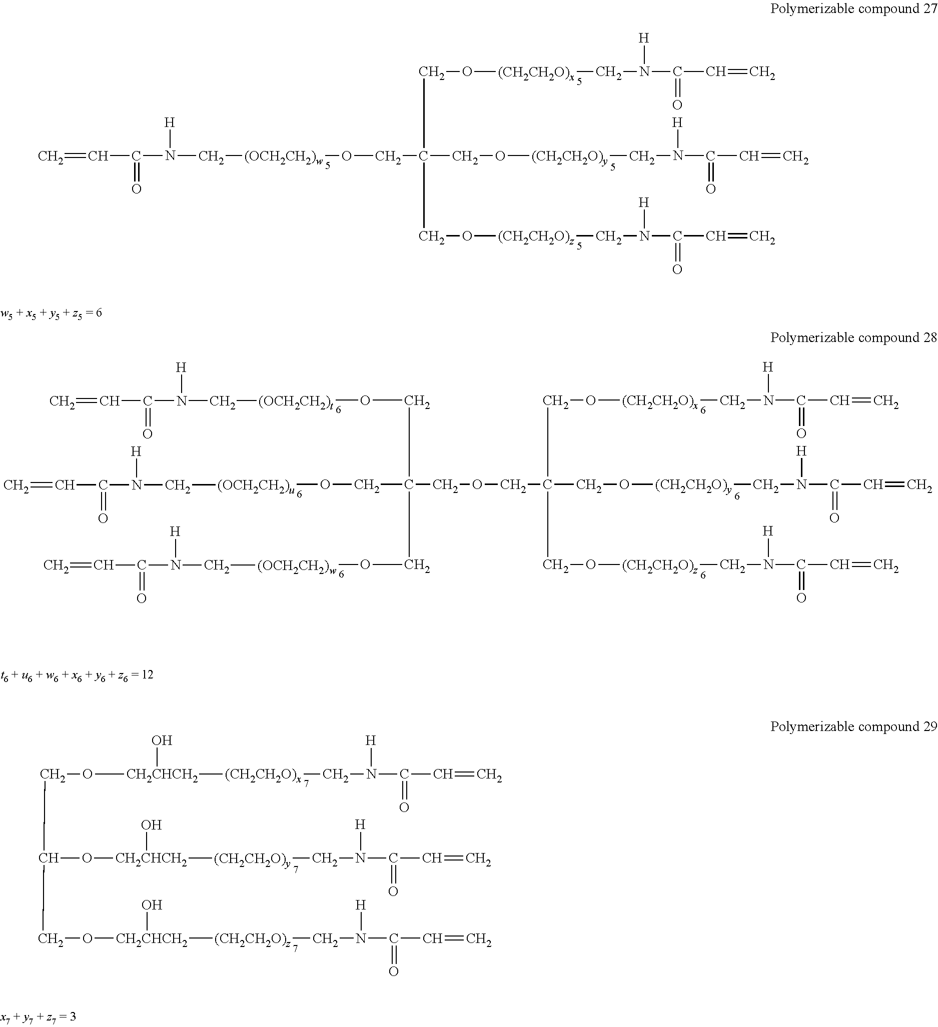

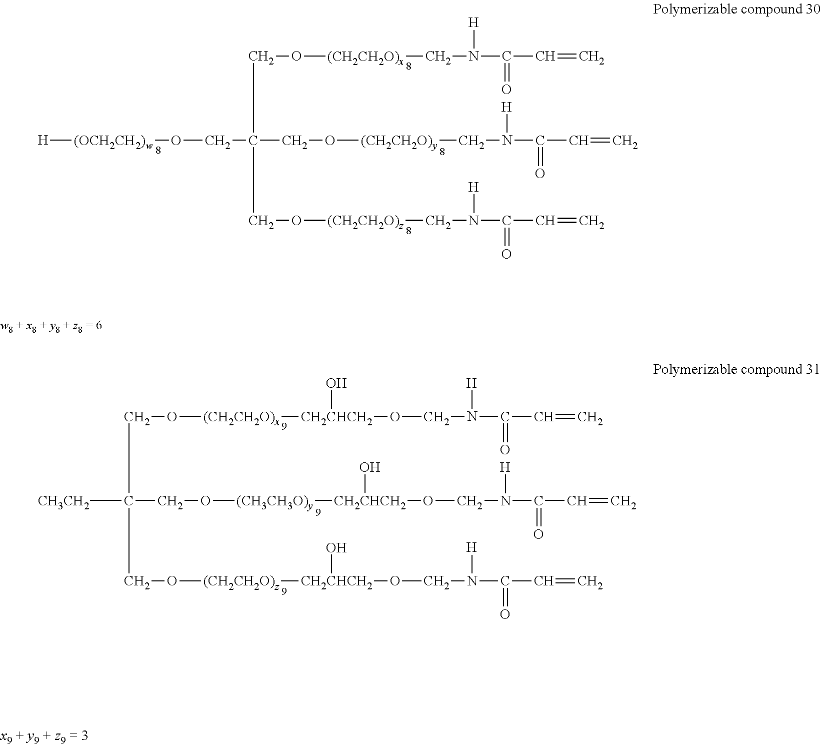

The ink composition in the present invention may contain one kind of the polymerizable compounds having a (meth)acrylamido structure, or may contain two or more kinds of them. In a case in which the ink composition in the invention contains two or more kinds of the polymerizable compounds having a (meth)acrylamido structure, it is preferable that the ink composition contains at least one monofunctional polymerizable compound having a (meth)acrylamido structure and at least one polyfunctional polymerizable compound having a (meth)acrylamido structure.

The content of the polymerizable compound having a (meth)acrylamido structure in the ink composition (in a case in which the ink composition contains two or more kinds of the polymerizable compounds having a (meth)acrylamido structure, the total content) is preferably from 5% by mass to 50% by mass, more preferably from 10% by mass to 30% by mass, and most preferably from 15% by mass to 25% by mass, with respect to the total mass of the ink composition.

<Pigment>

The ink composition in the present invention contains at least one pigment.

The pigment is not particularly limited and can be selected as appropriate according to the purpose. For example, the pigment may be an organic pigment or an inorganic pigment.

The pigment is preferably a pigment which is almost insoluble or slightly soluble in water, from the viewpoint of ink coloring property.

There is no particular limitation on the kind of the pigment, and a conventionally known organic pigment or inorganic pigment can be used.

Examples of the organic pigment include azo pigments, polycyclic pigments, dye chelates, nitro pigments, nitroso pigments, and aniline black. Among them, azo pigments and polycyclic pigments are more preferable. Examples of the azo pigments include azo lakes, insoluble azo pigments, condensed azo pigments, and chelate azo pigments. Examples of the polycyclic pigment include phthalocyanine pigments, perylene pigments, perinone pigments, anthraquinone pigments, quinacridone pigments, dioxazine pigments, indigo pigments, thio indigo pigments, isoindolinone pigments, and quinophthalone pigments. Examples of the dye chelates include basic dye chelates and acidic dye chelates.

Examples of the inorganic pigment include titanium oxide, iron oxide, calcium carbonate, barium sulfate, aluminium hydroxide, barium yellow, cadmium red, chrome yellow, and carbon black. Among them, carbon black is particularly preferable. The carbon black may be produced by a known method such as a contact method, a furnace method, or a thermal method.

Specific examples of the pigment which can be used in the invention include pigments described in paragraphs [0142] to [0145] of JP-A No. 2007-100071.

One kind of the pigments may be used alone, or plural kinds of pigments selected from any one or more of the groups described above may be used in combination.

The content of the pigment(s) in the ink composition is preferably from 1% by mass to 25% by mass, and more preferably from 2% by mass to 20% by mass, with respect to the total mass of the ink composition, from the viewpoints of color density, granularity, ink stability, and ejection reliability.

(Dispersant)

In the ink composition in the invention, the pigment is preferably dispersed by a dispersant.

The dispersant may be a polymer dispersant or a surfactant type dispersant having a low molecular weight, but a polymer dispersant is preferable. Further, the polymer dispersant may be a water soluble polymer dispersant or a water insoluble polymer dispersant.

Further, in the ink composition in the invention, it is preferable that, by dispersing the pigment using a polymer dispersant (resin), at least a portion of a surface of the pigment is covered with a resin. Hereinafter, the pigment in which at least a portion of the surface is covered with a resin may also be referred to as the “resin-coated pigment”.

The polymer dispersant may be a water soluble polymer dispersant or a water insoluble polymer dispersant.

The polymer dispersant is preferably a water insoluble polymer dispersant from the viewpoints of dispersion stability and ejection property in the case of applying an ink composition containing the water insoluble polymer dispersant to an inkjet system.

—Water Insoluble Polymer Dispersant—

The water insoluble polymer dispersant (hereinafter, may merely be referred to as the “dispersant”) is not particularly limited as far as it is a water insoluble polymer dispersant and can disperse a pigment, and a conventionally known water insoluble polymer dispersant can be used. The water insoluble polymer dispersant can be configured to include, for example, both a hydrophobic constituent unit and a hydrophilic constituent unit.

The term “water insoluble” used herein means that the amount of dissolution is 5.0 parts by mass or less, with respect to 100 parts by mass of water (at 25° C.).

Examples of a monomer that constitutes the hydrophobic constituent unit may include a styrene based monomer, alkyl (meth)acrylate, and aromatic group-containing (meth)acrylate.

The monomer that constitutes the hydrophilic constituent unit is not particularly limited as far as it is a monomer containing a hydrophilic group. Examples of the hydrophilic group may include a nonionic group, a carboxyl group, a sulfonic acid group and a phosphoric acid group. Examples of the nonionic group may include a hydroxyl group, an amido group (in which the nitrogen atom is unsubstituted), a group derived from an alkylene oxide polymer (for example, polyethylene oxide, polypropylene oxide, or the like), and a group derived from sugar alcohol.

From the viewpoint of dispersion stability, the hydrophilic constituent unit preferably contains at least a carboxyl group, and a mode in which the constituent unit contains both a nonionic group and a carboxyl group is also preferable.

Specific examples of the water insoluble polymer dispersant include a styrene-(meth)acrylic acid copolymer, a styrene-(meth)acrylic acid-(meth)acrylic acid ester copolymer, a (meth)acrylic acid ester-(meth)acrylic acid copolymer, a polyethylene glycol (meth)acrylate-(meth)acrylic acid copolymer, and a styrene-maleic acid copolymer.

From the viewpoint of dispersion stability of the pigment, the water insoluble polymer dispersant is preferably a vinyl polymer containing a carboxyl group, and more preferably a vinyl polymer having at least a constituent unit derived from an aromatic group-containing monomer as the hydrophobic constituent unit, and a constituent unit containing a carboxyl group as the hydrophilic constituent unit.

The weight average molecular weight of the water insoluble polymer dispersant is preferably from 3,000 to 200,000, more preferably from 5,000 to 100,000, even more preferably from 5,000 to 80,000, and particularly preferably from 10,000 to 60,000, from the viewpoint of dispersion stability of the pigment.

The content of the resin (water insoluble polymer) in the resin-coated pigment is preferably from 10% by mass to 100% by mass, more preferably from 20% by mass to 70% by mass, and particularly preferably from 30% by mass to 60% by mass, relative to the pigment, from the viewpoints of dispersibility of the pigment, ink coloring property, and dispersion stability.

When the content of the dispersant in the resin-coated pigment is within the above range, the pigment may be coated with an appropriate amount of the dispersant, and a colored particle which has a small particle diameter and has excellent stability over time tends to be easily obtained, which is preferable.

The resin-coated pigment may contain other dispersant, in addition to the water insoluble polymer dispersant. For example, a conventionally known water soluble low molecular weight dispersant, a water soluble polymer, or the like can be used. The dispersant other than the water insoluble polymer dispersant can be used within the above-described range of the content of the dispersant.

The resin-coated pigment is preferably configured to include the pigment and the water insoluble polymer dispersant, from the viewpoints of dispersion stability and ejection property.

The resin-coated pigment can be obtained in the form of a dispersion of the resin-coated pigment by, for example, dispersing a mixture including the pigment, the dispersant, and, as necessary, a solvent (preferably, an organic solvent) by using a disperser.

The resin-coated pigment dispersion can be produced as a dispersion by, for example, providing a process of adding an aqueous solution containing a basic substance to a mixture containing the pigment, the water-insoluble polymer dispersant, and an organic solvent which dissolves or disperses the dispersant (a mixing and hydration process) and then, a process of removing the organic solvent therefrom (a solvent removal process). In this manner, a resin-coated pigment dispersion, in which the pigment is finely dispersed and which has excellent storage stability, can be produced.

Here, it is preferable that the organic solvent can dissolve or disperse the dispersant. In addition, it is preferable that the organic solvent has a certain degree of affinity to water. Specifically, an organic solvent having a degree of solubility with respect to water at 20° C. of from 10% by mass to 50% by mass is preferable.

More specifically, the resin-coated pigment dispersion can be produced by a production method including the following process (1) and process (2), but the invention is not limited thereto.

Process (1): a process of dispersing a mixture including a colorant (a pigment), a dispersant, an organic solvent which dissolves or disperses the dispersant, as well as a solution containing a basic substance and water as a main component.

Process (2): a process of removing at least a portion of the organic solvent from the mixture after dispersion.

In process (1) above, first, the dispersant is dissolved or dispersed in an organic solvent to obtain a mixture (a mixing process). Subsequently, a colorant (a pigment), a solution containing a basic substance and water as a main component, water, and if necessary, a surfactant or the like are added to the mixture and mixed, and the resulting mixture is subjected to a dispersion treatment to obtain an oil-in-water type dispersion.

The basic substance is used for neutralizing anionic groups (preferably, carboxyl groups) which may be incorporated in the polymer. The degree of neutralization of the anionic groups is not particularly limited. Concerning the liquid properties of the finally obtained colorant particle dispersion, usually, it is preferable that the pH is from 4.5 to 10. The value of pH can also be determined according to the desired degree of neutralization of the polymer.

Preferable examples of the organic solvent include alcohol-based solvent, ketone-based solvent and ether-based solvent. Among them, the alcohol-based solvent includes ethanol, isopropanol, n-butanol, tert-butanol, isobutanol, diacetone alcohol and the like. The ketone-based solvent includes acetone, methyl ethyl ketone, diethyl ketone, methyl isobutyl ketone and the like. The ether-based solvent includes dibutyl ether, tetrahydrofuran, dioxane and the like. Among these solvents, isopropanol, acetone and methyl ethyl ketone are preferred, and methyl ethyl ketone is particularly preferred. The organic solvent may be used singularly or in a combination of plural kinds thereof.

In producing the resin-coated pigment dispersion, kneading and dispersion treatment may be carried out while applying a strong shear force by using a twin roll, a triple roll, a ball mill, a thoron mill, a Disper, a kneader, a co-kneader, a homogenizer, a blender, a single-screw extruder, a twin-screw extruder, or the like. Details on kneading and dispersion are described in, for example, “Paint Flow and Pigment Dispersion” written by T. C. Patton (published by John Wiley and Sons, Inc., 1964).

Further, as needs arise, the resin-coated pigment dispersion can be obtained by performing fine dispersion treatment with beads which have a particle diameter of from 0.01 mm to 1 mm and are made of glass, zirconia, or the like, using a vertical or horizontal sand grinder, a pin mill, a slit mill, an ultrasonic disperser, or the like.

Concerning the removal of the organic solvent in the production of the resin-coated pigment dispersion, the method of removing the organic solvent is not particularly limited, and the organic solvent can be removed by a known method such as distillation under reduced pressure.

The resin-coated pigment in the resin-coated pigment dispersion thus obtained maintains a good dispersion state, and the resulting colored particle dispersion has excellent stability over time.

The volume average particle diameter of the resin-coated pigment in the invention is preferably from 10 nm to 200 nm, more preferably from 10 nm to 150 nm, and even more preferably from 10 nm to 100 nm. When the volume average particle diameter is 200 nm or less, color reproducibility may become good, and in the case of using an inkjet system, jetting characteristics may become good. When the volume average particle diameter is 10 nm or more, lightfastness may be enhanced.

The volume average particle diameter of the resin-coated pigment can be measured using a NANOTRACK particle size distribution analyzer UPA-EX150 (trade name, manufactured by Nikkiso Co., Ltd.).

The particle size distribution of the resin-coated pigment is not particularly limited, and the pigment particles may have either a broad particle size distribution or a mono-dispersed particle size distribution. Two or more kinds of resin-coated pigments, each of which having a mono-dispersed particle size distribution, may be used in combination as a mixture.

The volume average particle diameter and particle size distribution of the resin-coated pigment can be measured, for example, by a dynamic light scattering method.

In the present invention, one kind of the resin-coated pigments may be used alone, or two or more kinds of them may be used in combination.

<Initiator>

The ink composition in the present invention includes therein at least one initiator (hereinafter, also referred to as polymerization initiator).

As the polymerization initiator, known polymerization initiators may be used. Among the above, a radical polymerization initiator is preferably used.

Examples of a preferred radical polymerization initiator include: (a) aromatic ketones; (b) acyl phosphine compounds; (c) aromatic onium salt compounds; (d) organic peroxides; (e) thio compounds; (f) hexa-aryl bi-imidazole compounds; (g) ketoxime ester compounds; (h) borate compounds; (i) azinium compounds; (j) methallocene compounds; (k) active ester compounds; (l) compounds having a carbon-halogen bond; and (m) alkylamine compounds.

Specific examples of the polymerization initiator may include polymerization initiators as described in page 65 to 148 of “SHIGAISEN KOKA SYSTEM” by Kiyoshi Kato (published by SOGO GIJYUTSU CENTER KK, 1989).

As the polymerization initiator in the present invention, a water soluble polymerization initiator or the like may be used. Note that, the term “water soluble” used in the polymerization initiator means that the initiator is dissolved in distilled water at 25° C. in an amount of 0.5% by mass or more. The water soluble polymerization initiator is preferably dissolved in distilled water at 25° C. in an amount of 1% by mass or more and more preferably 3% by mass or more.

Examples of the water soluble polymerization initiator may include a compound represented by the following Formula (A) and compounds described in JP-A No. 2005-307198.

Among the above, from the viewpoint of more effectively realizing the effect of the present invention, a water soluble polymerization initiator represented by the following Formula (A) is preferable.

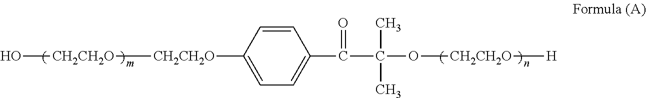

In Formula (A), m and n each independently represent an integer of 0 or more, and (m+n) represents an integer of 0 to 3. It is preferable that m is an integer of 0 to 3 and n is an integer of 0 or 1 in Formula (A).

Specific examples represented by Formula (A) are described below, but the invention is not limited thereto.

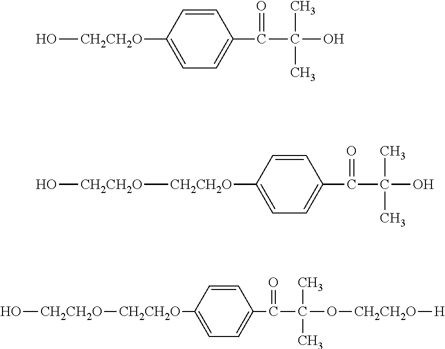

The compound represented by Formula (A) may be a compound synthesized according to the method described in JP-A No. 2005-307198 and the like, or may be a commercially available compound. An example of a compound, which is represented by Formula (A) and is commercially available, may be IRGACURE 2959 (m=0, and n=0).

In the ink composition in the present invention, one kind of the polymerization initiators may be used alone, or two or more of them may be used in combination.

The content of the polymerization initiator in the ink composition in the present invention is preferably in a range of from 0.1% by mass to 30% by mass in terms of solid content, more preferably in a range of from 0.5% by mass to 20% by mass, and more preferably in a range of from 1.0% by mass to 15% by mass.

The content of the polymerization initiator is preferably from 0.1% by mass to 20% by mass, more preferably from 0.1% by mass to 10% by mass, and particularly preferably from 1% by mass to 10% by mass, with respect to the total mass of the ink composition.

<Water>

The ink composition in the present invention contains water.

Namely, the ink composition in the present invention is an aqueous ink composition.

It is preferable to use water that does not contain ionic impurities, such as ion exchanged water or distilled water, as the water in the present invention.

The content of water in the ink composition is selected as appropriate according to the purpose, but is preferably from 10% by mass to 95% by mass, and more preferably from 30% by mass to 90% by mass.

<Water Soluble Organic Solvent>

An ink composition in the invention may include at least one of water soluble organic solvents. Here, the “water soluble” in the invention specifically means that a degree of solubility of the water soluble organic solvent is 1% by mass or more with respect to a total mass of water at 25° C. Examples of the water soluble organic solvent include alkanediols (polyhydric alcohols) such as glycerin, ethylene glycol, propylene glycol and the like; sugar alcohols; alkyl alcohols having 1 to 4 carbon atoms such as ethanol, methanol, butanol, propanol, isopropanol and the like; glycol ethers such as ethylene glycol monomethyl ether, ethylene glycol monoethyl ether, ethylene glycol monobutyl ether, ethylene glycol monomethyl ether acetate, diethylene glycol monomethyl ether, diethylene glycol monoethyl ether, diethylene glycol mono-n-propyl ether, ethylene glycol monoisopropyl ether, diethylene glycol monoisopropyl ether, ethylene glycol mono-n-butyl ether, ethylene glycol mono-t-butyl ether, diethylene glycol mono-t-butyl ether, triethylene glycol monoethyl ether, 1-methyl-1-methoxybutanol, propylene glycol monomethyl ether, propylene glycol monoethyl ether, propylene glycol mono-t-butyl ether, propylene glycol mono-n-propyl ether, propylene glycol monoisopropyl ether, dipropylene glycol, dipropylene glycol monomethyl ether, dipropylene glycol monoethyl ether, dipropylene glycol mono-n-propyl ether, dipropylene glycol monoisopropyl ether, tripropylene glycol monomethyl ether and the like. The water soluble organic solvent may be used singularly or in a combination of two kinds or more thereof.

As the water soluble organic solvent, known water soluble organic solvents as described in, for example, paragraphs 0124 to 0135 of JP-A No. 2011-074150 and paragraphs 0104 to 0119 of JP-A No. 2011-079901 can also be used.

In a case in which the ink composition in the present invention contains a water soluble organic solvent, the content of the water soluble organic solvent is preferably 60% by mass or lower, and more preferably 40% by mass or lower, with respect to the total mass of the ink composition.

<Surfactant>

The ink composition in the present invention may include, as necessary, at least one surfactant. The surfactant may be used as a surface tension adjuster.

As the surface tension adjuster, a compound having a structure in which both a hydrophilic moiety and a hydrophobic moiety are contained in the molecule, or the like can be effectively used, and any of an anionic surfactant, a cationic surfactant, an amphoteric surfactant, a nonionic surfactant, or a betaine surfactant can be used. Further, the dispersant described above (a polymer dispersant) may also be used as a surfactant.

In the present invention, a nonionic surfactant is preferable from the viewpoint of suppression of interference between spotted ink droplets. Above all, acetylene glycol derivatives (acetylene glycol based surfactants) are more preferable.

Examples of the acetylene glycol based surfactants may include 2,4,7,9-tetramethyl-5-decyne-4,7-diol and an alkylene oxide adduct of 2,4,7,9-tetramethyl-5-decyne-4,7-diol, and at least one selected from the above surfactants is preferable. Examples of commercially available products of these compounds may include E series such as OLFINE E1010 (trade name, manufactured by Nissin Chemical Industry Co., Ltd.).

In a case in which the ink composition contains a surfactant (a surface tension adjuster), the addition amount of the surfactant is preferably an addition amount that adjusts the surface tension of the ink composition to 20 mN/m to 60 mN/m, from the viewpoint of well ejecting the ink composition in accordance with an inkjet system. From the viewpoint of surface tension, the addition amount of the surfactant is more preferably an addition amount that adjusts the surface tension of the ink composition to 20 mN/m to 45 mN/m, and even more preferably an addition amount that adjusts the surface tension of the ink composition to 25 mN/m to 40 mN/m.

Specifically, the content of the surfactant in the ink composition is not particularly limited except that the range which gives the surface tension described above is preferable. The content of the surfactant in the ink composition is preferably 0.1% by mass or higher, more preferably from 0.1% by mass to 10% by mass, and even more preferably from 0.2% by mass to 3% by mass.

<Solid Moistening Agent>

The ink composition in the present invention may include a solid moistening agent.

As used herein, the term “solid moistening agent” means a water soluble compound which has water-holding capacity and is solid at 25° C. The solid moistening agent has a high moisture-holding capacity and a function of preventing undesired drying or solidification of ink as a solid moistening agent, and can be suitably used in the ink composition according to the present invention.

A generally used solid moistening agent for use in aqueous ink compositions can be used as it is, as the solid moistening agent. Specific examples thereof include urea, urea derivatives, and polyhydric alcohols such as saccharides, sugar alcohols, hyaluronic acids, trimethylolpropane, and 1,2,6-hexanetriol.

Examples of the urea derivatives include a compound obtained by replacing hydrogen on the nitrogen of urea by an alkyl group or alkanol, thiourea, and a compound obtained by replacing hydrogen on the nitrogen of thiourea by an alkyl group or alkanol. Specific examples thereof include N,N-dimethylurea, thiourea, ethyleneurea, hydroxyethylurea, hydroxybutylurea, ethylenethiourea, and diethylthiourea.

Examples of the saccharides include monosaccharides, disaccharides, oligosaccharides (including trisaccharides and tetrasaccharides), and polysaccharides. Specific examples thereof include glucose, mannnose, fructose, ribose, xylose, arabinose, galactose, aldonic acid, glucitol, (sorbitol), maltose, cellobiose, lactose, sucrose, trehalose, and maltotriose. As used herein, the term “polysaccharides” refers to sugars in a broad sense, and encompasses substances widely spread in nature, such as alginic acid, α-cyclodextrin, and cellulose. Examples of derivatives of these saccharides include reducing sugars (for example, sugar alcohols) of the above saccharides, and oxidized sugars (for example, aldonic acids, uronic acids, amino acids, thiosugar, or the like) of the above saccharides. In particular, sugar alcohols are preferable, and specific examples thereof include maltitol, sorbitol, and xylitol. A commercially available 1% aqueous solution of sodium hyaluronate (molecular weight: 350,000) may be used as a salt of hyaluronic acid.

In a case in which the ink composition according to the invention contains a solid moistening agent, the content of the solid moistening agent is preferably 1.0% by mass or higher but lower than 20.0% by mass, more preferably 2.0% by mass or higher but lower than 15.0% by mass, and even more preferably 3.0% by mass or higher but lower than 10.0% by mass, with respect to the total amount of the ink composition, from the viewpoints of improving removability by wiping off and the like.

Here, in a case in which two or more kinds of the solid moistening agents are incorporated in the ink composition according to the invention, it is enough that the total amount of the two or more kinds of the solid moistening agents is within the above range.

<Other Components>

The ink composition in the present invention may further contain, as necessary, various additives as other components.

Examples of the additives include known additives such as an ultraviolet absorbent, an anti-fading agent, a mildew-proofing agent, a pH adjuster, an anti-rust agent, an antioxidant, an emulsification stabilizer, an antiseptic, an antifoaming agent, a viscosity adjuster, a dispersion stabilizer, or a chelating agent.

Examples of the ultraviolet absorbent include a benzophenone ultraviolet absorbent, a benzotriazole ultraviolet absorbent, a salicylate ultraviolet absorbent, a cyanoacrylate ultraviolet absorbent, and a nickel complex salt ultraviolet absorbent.

As the anti-fading agent, an organic anti-fading agent or a metal complex anti-fading agent may be used. Examples of the organic anti-fading agent include hydroquinones, alkoxyphenols, dialkoxyphenols, phenols, anilines, amines, indanes, chromanes, alkoxyanilines and heterocyclic compounds. Examples of the metal complex anti-fading agent include nickel complexes and zinc complexes.

Examples of the mildew-proofing agents include sodium dehydroacetate, sodium benzoate, sodium pyridinethion-1-oxide, ethyl p-hydroxybenzoate, 1,2-benzoisothiazolin-3-one, sodium sorbate and sodium pentachlorophenolate. The content of the mildew-proofing agent in the ink composition is preferably in a range of from 0.02% by mass to 1.00% by mass.

The pH adjuster is not particularly limited as far as the pH adjuster can adjust the pH to a desired value without exerting adverse influence on the ink composition to be prepared, and the pH adjuster may be selected as appropriate depending on the purpose. Examples of the pH adjuster include alcohol amines (for example, diethanol amine, triethanol amine, 2-amino-2-ethyl-1,3-propanediol, or the like), alkali metal hydroxides (for example, lithium hydroxide, sodium hydroxide, potassium hydroxide, or the like), ammonium hydroxides (for example, ammonium hydroxide, quaternary ammonium hydroxide, or the like), phosphonium hydroxides, and alkali metal carbonates.

Examples of the anti-rust agent include acid sulfite, sodium thiosulfate, ammonium thiodiglycolate, diisopropyl ammonium nitrite, pentaerythritol tetranitrate, and dicyclohexyl ammonium nitrite.

Examples of the antioxidant include a phenol antioxidant (including a hindered phenol antioxidant), an amine antioxidant, a sulfur antioxidant, and a phosphorus antioxidant.

Examples of the chelating agent include ethylenediaminetetraacetic acid sodium salt, nitrilotriacetic acid sodium salt, hydroxyethylethylenediaminetriacetic acid sodium salt, diethylenetriaminepentaacetic acid sodium salt, and uramildiacetic acid sodium salt.

<Physical Properties of the Ink Composition>

The surface tension (at 25° C.) of the ink composition in the invention is preferably from 20 mN/m to 60 mN/m, more preferably from 20 mN/m to 45 mN/m, and even more preferably from 25 mN/m to 40 mN/m.

The surface tension of the ink composition is measured using AUTOMATIC SURFACE TENSIOMETER CBVP-Z (trade name, manufactured by Kyowa Interface Science Co. Ltd.) under the condition of 25° C.

The viscosity of the ink composition in the invention at 25° C. is preferably from 1.2 mPa·s to 15.0 mPa·s, more preferably 2 mPa·s or more but less than 13 mPa·s, and even more preferably 2.5 mPa·s or more but less than 10 mPa·s.

The viscosity of the ink composition is measured using VISCOMETER TV-22 (trade name, manufactured by TOKI SANGYO CO., LTD.) under the condition of 25° C.

<<Maintenance Liquid>>

The maintenance liquid in the present invention contains at least one compound (hereinafter, may also be referred to as “specific compound”) having an SP value of from 8.00 (cal/cm³)^{1/2} to 12.00 (cal/cm³)^{1/2}.

When the specific compound is incorporated in the maintenance liquid, the maintenance property with respect to the above-described ink composition may be remarkably improved, and the re-ejection property of the above-described ink composition after maintenance using the maintenance liquid may be remarkably improved.

From the viewpoint of more effectively realizing such effects, the content of the specific compound (in the case of using two or more specific compounds, the total content; hereinafter the same applies.) is preferably 10% by mass or higher, and more preferably 20% by mass or higher, with respect to the total amount of the maintenance liquid.

The maintenance liquid in the present invention preferably contains water, from the viewpoint of improvement in maintenance property.

In a case in which the maintenance liquid contains water, there is no particular limitation as to the content of water, but from the viewpoint of improvement in maintenance property, it is preferably that the content of water with respect to the total amount of the maintenance liquid is 50% by mass or higher.

In a case in which the maintenance liquid contains water, the specific compound is preferably the main component in the components obtained by removing water from the maintenance liquid.

The term “main component” used herein refers to a component whose content ratio is the highest.

Preferably, in a case in which the maintenance liquid contains water, the content of the specific compound is preferably 60% by mass or higher, more preferably 70% by mass or higher, and particularly preferably 80% by mass or higher, with respect to the total mass of the residue obtained by removing water from the maintenance liquid.

The SP value of the specific compound is more preferably from 8.50 (cal/cm³)^{1/2} to 11.50 (cal/cm³)^{1/2}, from the viewpoint of further improving the maintenance property and re-ejection property after maintenance.

<Compound Having an SP Value of from 8.00 (cal/cm³)^{1/2} to 12.00 (cal/cm³)^{1/2}>

The compound (specific compound) having an SP value of from 8.00 (cal/cm³)^{1/2} to 12.00 (cal/cm³)^{1/2} is not particularly limited as far as the SP value satisfies this range, and examples of the compound include water soluble organic solvents. Here, the term “water soluble” means that a degree of solubility of the specific compound with respect to water at 25° C. is 1% by mass or more.

As the water soluble organic solvent, which is the specific compound, an organic solvent which has an SP value of from 8.00 (cal/cm³)^{1/2} to 12.00 (cal/cm³)^{1/2} may be selected as appropriate from the organic solvents described, for example, in paragraphs 0026 to 0038 of JP-A No. 2011-68085 and used.

The water soluble organic solvent which is the specific compound is particularly preferably a polyalkyleneoxy alkyl ether whose SP value satisfies the above range.

Specific examples of the water soluble organic solvent, which is the specific compound, include the following compounds. However, the present invention is not limited to these specific examples. The numeric value in the parentheses represents the SP value (unit: cal/cm³)^{1/2}).
diethylene glycol monoethyl ether (10.95)
diethylene glycol monobutyl ether (10.51)
triethylene glycol monobutyl ether (10.31)
dipropylene glycol monomethyl ether (10.41)
methyl ethyl ketone (8.98)
diethylene glycol monomethyl ether (11.22)

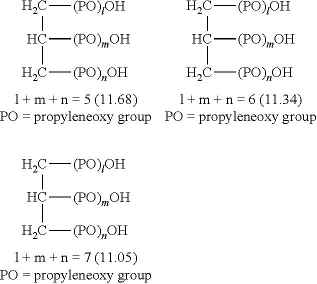

nC₄H₉O(AO)₄—H (AO represents EO or PO, a ratio of EO:PO is 1:1) (9.83)
nC₄H₉O(AO)₁₀—H (AO represents EO or PO, a ratio of EO:PO is 1:1) (9.19)
HO(A′O)₄₀—H(NO represents EO or PO, a ratio of EO:PO is 1:3) (9.14)
HO(A″O)₅₅—H (A″O represents EO or PO, a ratio of EO:PO is 5:6) (9.19)
HO(PO)₇—H (10.36)

wherein EO represents an ethyleneoxy group, and PO represents a propyleneoxy group.

The water soluble organic solvent may be used singularly or in a combination of two kinds or more thereof.

<pH>

The pH of the maintenance liquid in the present invention is preferably from 6.0 to 8.0, more preferably from 6.5 to 8.0, and even more preferably from 7.0 to 7.8.

When the pH of the maintenance liquid is 6.0 or higher, the maintenance property and the re-ejection property after maintenance can be further improved.

When the pH of the maintenance liquid is 8.0 or lower, damages to members (members made of a metal, a liquid repellent film having a fluoroalkyl group, which is provided on a surface of a member, and the like), such as the inkjet head and the like, due to the maintenance liquid may be further suppressed.

The maintenance liquid according to the invention preferably contains a basic compound and an acidic compound from the viewpoint of ease of adjusting the pH of the maintenance liquid according to the invention to be within the above range.

Particularly, by using a basic compound having a pKa value in a range of from 6.0 to 8.5 and an acidic compound in combination, a maintenance liquid, which has a high buffer capacity in a preferable pH region and has an especially excellent pH stabilization effect, may be obtained.

<Basic Compound>

As the basic compound, a compound having a degree of solubility with respect to a solvent of the maintenance liquid (for example, water, mixed solvent of water and an organic solvent, or the like) of 5 mmol/L or more can be suitably used.

The basic compound may be an inorganic compound or an organic compound, but an organic basic compound is more preferable from the viewpoints of ease of obtaining a pKa in a desirable range and solubility with respect to the maintenance liquid. The basic compound may be either a monobasic compound or a polybasic compound. The pKa value in the case of an organic basic compound is the pKa value of the conjugate acid.

The pKa value of the basic compound is preferably in a range of from 6.0 to 8.5, more preferably from 6.5 to 8.4, and even more preferable from 6.8 to 8.3, from the viewpoint of effectively having a pH buffer capacity within the preferable pH range of the maintenance liquid.

Examples of the basic compound that satisfies the above conditions include the following specific compounds.
Cacodylic acid (pKa: 6.2)
2,2-Bis(hydroxymethyl)-2,2′,2″-nitrilotriethanol (pKa: 6.5)
piperazine-N,N′-bis(2-ethanesulfuric acid) (pKa: 6.8)
Phosphoric acid (pKa2: 6.86)
Imidazole (pKa: 7.0)
N-2-hydroxyethylpiperazine-N′-2-ethanesulfuric acid (pKa: 7.6)
N-methylmorpholine (pKa: 7.8)
Triethanolamine (pKa: 7.8)
Hydrazine (pKa: 8.11)
Tris(hydroxymethyl)aminomethane (pKa: 8.3)

<Acidic Compound>

The acidic compound is not particularly limited, and any of an organic acid and an inorganic acid may be employed. Examples of the inorganic acid include hydrochloric acid, sulfuric acid, sulfurous acid, nitric acid, and phosphoric acid. Examples of the organic acid include acetic acid, tartaric acid, salicylic acid, sulfosalicylic acid, and benzoic acid. The acidic compound contained in the treatment liquid in the invention is preferably an inorganic acid. Further, any of a strong acid and a weak acid may be used, but from the viewpoint of high pH buffer capacity, a strong acid is preferable.

One kind of the acidic compounds may be used, or two or more of them may be used in combination.

The addition amount of the acidic compound, in terms of acid equivalent, is preferably from 0.05 equivalents to 0.95 equivalents of the basic compound, more preferably from 0.10 equivalents to 0.90 equivalents, and even more preferably from 0.15 equivalents to 0.85 equivalents, from the viewpoint of high pH buffer capacity of the maintenance liquid. In the case of using plural acidic compounds, it is preferably that a total amount thereof falls within the above range.

A preferable combination of the basic compound and the acidic compound in the present invention is a combination of an organic basic compound and an inorganic acid.

<Surfactant>

The maintenance liquid in the present invention may include at least one surfactant. As the surfactant, a surfactant that functions as a surface tension adjuster is preferable.

Specific examples of the surfactant include anionic surfactants such as fatty acid salts, alkylcarboxylic acid salts, alkyl sulfuric acid ester salts, alkylsulfonic acid salts, alkylbenzenesulfonic acid salts, alkylnaphthalenesulfonic acid salts, dialkyl sulfosuccinate salts, alkyl phosphoric acid ester salts, naphthalenesulfonic acid-formalin condensates and polyoxyethylene alkyl sulfuric acid salts; and nonionic surfactants such as polyoxyethylene alkyl ether, polyoxyethylene alkyl allyl ether, polyoxyethylene fatty acid ester, sorbitan fatty acid ester, polyoxyethylene sorbitan fatty acid ester, acetylenediol derivatives, polyoxyethylene alkyl amine, glycerin fatty acid ester and oxyethylene oxypropylene block copolymer.

Among the above, acetylenediol derivatives, alkylcarboxylic acid sodium salts or alkylsulfonic acid sodium salts are preferable from viewpoints of prevention of aggregation reaction with a component(s) in the ink composition, and the like.

A content of the surfactant in the maintenance liquid is preferably in a range of from 0.5% by mass to 10% by mass, and more preferably in a range of from 1% by mass to 3% by mass with respect to a total mass of the maintenance liquid. When the content of the surfactant is in the range above, it is advantageous in terms of detergency performance (maintenance property).

<Other Additives>

The maintenance liquid in the present invention may contain, as necessary, in addition to the components described above, other additives such as an anti-fading agent, an emulsification stabilizer, a penetration accelerator, an ultraviolet absorbent, an antiseptic, a mildew-proofing agent, a pH adjuster, a surface tension adjuster (a nonionic surfactant, a cationic surfactant, an anionic surfactant, a betaine surfactant, or the like), an antifoaming agent, or a viscosity adjuster.

<Physical Properties of the Maintenance Liquid and the Like>

The maintenance liquid in the present invention is preferably a liquid that does not cause formation of an aggregate when mixed with the ink composition in the present invention. It is because, when formation of an aggregate is caused, the component such as a pigment in the ink composition may further adhere to the inkjet head and the like, resulting in reducing the effect of the invention.

From the viewpoint of working property, the viscosity of the maintenance liquid at 20° C. is preferably from 1 mPa·s to 1000 mPa·s, more preferably 1 mPa·s or more but less than 500 mPa·s, and even more preferably 2 mPa·s or more but less than 100 mPa·s.

In the invention, the viscosity is measured by substantially the same method as the measuring method described in the above paragraph of “Ink composition”.

It is preferable that the maintenance liquid in the present invention is a colorless liquid that does not contain a pigment.

Further, the content of solids (25° C.) in the maintenance liquid is not particularly limited, but from the viewpoint of preventing residual solids after washing, it is preferably 5% by mass or lower, and more preferably 2% by mass or lower.

Furthermore, in the present invention, from the viewpoints of prevention of drying, improvement in wettability, and improvement in permeation property, an additional solvent other than the water soluble organic solvent, which is the specific compound, may also be used in combination as far as the effects of the invention are not impaired. As the additional solvent, a known solvent can be used.

<<Treatment Liquid>>

The ink set of the present invention preferably includes at least one kind of treatment liquid which contains an aggregating agent that can aggregate components in the above-described ink composition in the present invention.

By using the treatment liquid together with the above-described ink composition in the present invention, inkjet recording may be speeded up, and even when high speed recording is performed, an image having high density, high resolution, and excellent imaging characteristics (for example, reproducibility of fine lines or fine portions) may be obtained.

Further, when the treatment liquid includes an aggregating agent, an image with good image quality and excellent blocking resistance may be formed.

(Aggregating Agent)

The treatment liquid contains an aggregating agent that aggregates the components in the ink composition.

The aggregating agent is a substance that can coagulate (fix) the ink composition when the aggregating agent is brought into contact with the ink composition on the recording medium, and functions as a fixing agent. For example, when the treatment liquid is applied onto a recording medium (preferably, coated paper), followed by further applying droplets of the ink composition onto the recording medium that is in the state in which an aggregating agent is present thereon, the ink composition contacts with the aggregating agent, whereby the components in the ink composition aggregate and, as a result, the ink composition can be fixed on the recording medium.

Examples of the component for fixing the components in the ink composition may include acidic compounds, cationic polymers, and polyvalent metal salts. One of these components for fixing may be used alone, or two or more of them may be used in combination.

—Acidic Compound—

Preferable examples of the acidic compound include sulfuric acid, hydrochloric acid, nitric acid, phosphoric acid, polyacrylic acid, acetic acid, glycoric acid, malonic acid, malic acid, maleic acid, ascorbic acid, succinic acid, glutaric acid, fumaric acid, citric acid, tartaric acid, lactic acid, sulfonic acid, orthophosphoric acid, metaphosphoric acid, pyrrolidone carboxylic acid, pyrone carboxylic acid, pyrrole carboxylic acid, furan carboxylic acid, pyridine carboxylic acid, coumalic acid, thiophene carboxylic acid, nicotinic acid, or derivatives of such compound or salts thereof.

Among the above, an acidic compound having high solubility with respect to water is preferable. An acidic compound of tribasic or less is preferable, and an acidic compound of dibasic or more and tribasic or less is more preferable from the viewpoint of fixing of the whole printed ink composition due to reaction with the component(s) in the ink composition. One of these acidic compounds may be used alone or two or more thereof may be used together.

When the treatment liquid contains the acidic compound, the pH value of the treatment liquid at 25° C. is preferably from 0.1 to 6.8, more preferably from 0.5 to 6.0, and even more preferably from 0.8 to 5.0.

A content of the acidic compound is preferably 40% by mass or less, and more preferably in a range of from 15% by mass to 40% by mass with respect to a total mass of the treatment liquid. In a case where the content of the acidic compound is in a range of from 15% by mass to 40% by mass, components in the ink composition may be fixed more efficiently in the fixing process. The content of the acidic compound is even more preferably in a range of from 15% by mass to 35% by mass with respect to the total mass of the treatment liquid.

—Polyvalent Metal Salt—

The polyvalent metal salt is a compound containing a metal having a valency of 2 or more, such as an alkaline earth metal or a metal belonging to the group including zinc. Examples thereof may include acetic acid salts and oxides of a metal ion such as Ca²⁺, Cu²⁺, or Al³⁺.

In a case in which the ink composition is ejected onto the recording medium to which the treatment liquid containing the polyvalent metal salt has been applied, the aggregation reaction of the ink composition may be achieved by reducing the dispersion stability of the particles dispersed in the ink composition, for example, particles of a pigment, resin particles, or the like, and by increasing the viscosity of the whole ink composition. For example, when the particles such as the particles of the pigment or resin particles in the ink composition have weakly acidic functional groups such as carboxyl groups or the like, the particles are stably dispersed by the action of the weakly acidic functional groups; however, by reducing the surface charges of the particles due to the interaction between the particles and the polyvalent metal salt, the dispersion stability can be reduced. Therefore, from the viewpoint of aggregation reaction, the polyvalent metal salt which is included in the treatment liquid as the fixing agent should have a valency of 2 or more, that is, the polyvalent metal salt should be a polyvalent metal salt of a polyvalent metal ion, and from the viewpoint of the reactivity of aggregation, the polyvalent metal salt is preferably a polyvalent metal salt of a polyvalent metal ion having a valency of 3 or more.

From the viewpoints described above, the polyvalent metal salt which can be used in the treatment liquid in the invention is preferably one or more selected from the group consisting of salts of the following polyvalent metal ion and anion, poly aluminum hydroxides, and poly aluminum chlorides.

Examples of the polyvalent metal ion include Ca²⁺, Cu²⁺, Ni²⁺, Mg²⁺, Sr²⁺, Zn²⁺, Ba²⁺, Al³⁺, Fe³⁺, Cr³⁺, Co³⁺, Fe²⁺, La³⁺, Nd³⁺, Y³⁺, and Zr⁴⁺. A salt of the above polyvalent metal may be used in order to add the polyvalent metal ion into the treatment liquid.

Here, the term “salt” means a metal salt formed from a polyvalent metal ion as described above and an anion which bonds with the ion. It is preferable that the salt is soluble in a solvent. Here, the term “solvent” means a medium which is included in the treatment liquid together with the polyvalent metal salt, and examples of the solvent include water and the organic solvents described below.

Preferable examples of the anion for forming a salt with the polyvalent metal ion include Cl⁻, NO₃⁻, Br⁻, ClO₃⁻, CH₃COO⁻, and SO₄²⁻.

The salt of polyvalent metal ion and anion may be formed from one or plural polyvalent metal ions and one or plural anions.

Examples of polyvalent metal salts other than those described above include poly aluminum hydroxides and poly aluminum chlorides.

From the viewpoints of reactivity, coloring property, easiness for handling, and the like, it is preferable to use a salt of polyvalent metal ion and anion, as the polyvalent metal salt. As the polyvalent metal ion, at least one selected from the group consisting of Ca²⁺, Mg²⁺, Sr²⁺, Al³⁺, and Y³⁺ preferable, and Ca²⁺ is more preferable.

Further, as the anion, NO₃⁻ is particularly preferable from the viewpoints of solubility and the like.

One of the polyvalent metal salts may be used alone, or two or more of them may be used as a mixture.

The content of the polyvalent metal salt is 15% by mass or higher with respect to the total mass of the treatment liquid. Thereby, the components in the ink composition can be more effectively fixed.

The content of the polyvalent metal salt is preferably from 15% by mass to 35% by mass, with respect to the total mass of the treatment liquid.

The amount of the polyvalent metal salt to be applied onto the recording medium is not particularly limited as far as the amount is enough to coagulate the ink composition, but from the viewpoint of ease of fixation of the ink composition, the application amount of the polyvalent metal salt is preferably from 0.5 g/m² to 4.0 g/m², and more preferably from 0.9 g/m² to 3.75 g/m².

—Cationic Polymer—

The cationic polymer is at least one cationic polymer selected from the group consisting of poly(vinylpyridine) salts, polyalkylamino ethyl acrylates, polyalkylamino ethyl methacrylates, poly(vinyl imidazole), polyethylene imine, polybiguanides, and polyguanides.

One of the cationic polymers may be used alone, or two or more of them may be used in combination.

Among the above cationic polymers, polyguanides (preferably, poly(hexamethylene guanidine) acetate, polymonoguanide, and polymeric biguanide), polyethylene imine, and poly(vinyl pyridine) are preferable, which are each advantageous in view of aggregation speed.

Concerning the weight average molecular weight of the cationic polymer, a smaller molecular weight is more preferable from the viewpoint of the viscosity of the treatment liquid. In the case of applying the treatment liquid onto a recording medium in accordance with an inkjet system, the weight average molecular weight of the cationic polymer is preferably in a range of from 500 to 500,000, more preferably in a range of from 700 to 200,000, and even more preferably in a range of from 1,000 to 100,000. When the weight average molecular weight of the cationic polymer is 500 or more, it is advantageous in view of aggregation speed, and when the weight average molecular weight is 500,000 or less, it is advantageous in terms of ejection reliability. However, the above ranges do not necessarily apply in the case of applying the treatment liquid onto the recording medium by a method other than inkjet.

In a case in which the treatment liquid contains a cationic polymer, the pH (at 25° C.) of the treatment liquid is preferably from 1.0 to 10.0, more preferably from 2.0 to 9.0, and even more preferably from 3.0 to 7.0.

The content of the cationic polymer is preferably from 1% by mass to 35% by mass, and more preferably from 5% by mass to 25% by mass, with respect to the total mass of the treatment liquid.

The amount of the cationic polymer to be applied onto coated paper is not particularly limited as far as the amount is enough to stabilize the ink composition, but from the viewpoint of ease of fixation of the ink composition, the application amount of the cationic polymer is preferably from 0.5 g/m² to 4.0 g/m², and more preferably from 0.9 g/m² to 3.75 g/m².

<<Image Forming Method>>

The image forming method of the present invention uses the above-described ink set of the present invention and includes an ink applying process of ejecting the above-described ink composition in the present invention from an inkjet head onto a recording medium and an ink removal process of removing the ink composition adhered to the inkjet head by using the maintenance liquid described above. The image forming method of the present invention may further include other processes, as necessary.

<Ink Applying Process>

The ink application process is a process of applying the above-described ink composition in the invention, from an inkjet head onto a recording medium.

In this process, the ink composition can be selectively applied onto the recording medium, and a desired visible image can be formed. Details of the ink composition such as constitution, preferable embodiments, of the ink composition, and the like are as described above in the explanation of the ink composition.

Image recording utilizing the inkjet process can be performed, specifically, by supplying energy thereby ejecting an ink composition to a desired recording medium, that is, plain paper, resin-coated paper, paper used exclusively for inkjet recording described, for example, in JP-A Nos. 8-169172, 8-27693, 2-276670, 7-276789, 9-323475, 62-238783, 10-153989, 10-217473, 10-235995, 10-217597, and 10-337947, films, common use paper for electrophotography, clothes, glass, metals, ceramics, etc. As the inkjet recording method suitable to exemplary embodiments of the invention, a method described in JP-A No. 2003-306623, in paragraphs (0093) to (0105) may be applicable.

The inkjet method is not particularly limited and may be of any known system, for example, a charge control system of ejecting an ink utilizing an electrostatic attraction force, a drop on demand system of utilizing a vibration pressure of a piezo element (pressure pulse system), an acoustic inkjet system of converting electric signals into acoustic beams, irradiating them to an ink, and ejecting the ink utilizing a radiation pressure, and a thermal inkjet system of heating an ink to form bubbles and utilizing the resultant pressure (BUBBLEJET (registered trade mark)). As the inkjet method, in particular, an inkjet method, which is a method described in JP-A No. 54-59936 and in which an ink that has been subjected to thermal energy undergoes rapid volume change and is discharged from a nozzle due to an acting force according to this change in state, may be effectively used in the invention.

Examples of the inkjet method include a system of injecting a number of ink droplets of low concentration, a so-called “photo-ink” each in a small volume, a system of improving an image quality using plural inks of a substantially identical hue and of different concentrations, and a system of using a colorless transparent ink.

The inkjet head used in the inkjet method may be either an on-demand system or a continuous system. The ejection system includes, specifically, for example, an electric-mechanical conversion system (for example, single cavity type, double cavity type, bender type, piston type, share mode type, and shared wall type, etc.), an electric-thermal conversion system (for example, thermal inkjet type, BUBBLEJET (registered trade mark) type, etc.), an electrostatic attraction system (for example, electric field control type, and slit jet type, etc.), and an electric ejecting system (for example, spark jet type, etc.) and any of the ejection systems may be used.

Ink nozzles, etc. used for recording by the inkjet method are not particularly limited but can be selected properly depending on the purpose.

Specific examples of the inkjet recording method include those described below.

(1) A method called electrostatic attraction system, in which a strong electric field is applied between a nozzle and an accelerating electrode disposed in front of the nozzle so as to successively jet ink droplets from the nozzle, print information signals are supplied to deflection electrodes while the ink droplets pass a gap between the deflection electrodes so that the ink droplets are jetted towards a recording medium, and the ink is fixed on the recording medium to record an image, or in which ink droplets are jetted from a nozzle towards a recording medium, without being deflected, according to print information signals and an image is thereby fixed on the recording medium.

(2) A method in which a pressure is applied to an ink liquid by a small-sized pump and an inkjet nozzle is mechanically vibrated using a crystal oscillator or the like, thereby forcibly jetting ink droplets from the nozzle. The ink droplets jetted from the nozzle is electrically charged simultaneously with the jetting, and print information signals are supplied to deflection electrodes while the ink droplets pass a gap between the deflection electrodes so as to jet the ink droplets towards a recording medium, and an image is thereby recorded on the recording medium.

(3) A piezo method in which pressure and print information signal are simultaneously applied to an ink liquid by a piezoelectric device, so that ink droplets are jetted from a nozzle towards a recording medium and an image is thereby recorded on the recording medium.

(4) A BUBBLE-JET (registered trademark) method, in which an ink liquid is heated and bubbled by a microelectrode according to print signal information, and the bubbles are allowed to expand so that the ink liquid is jetted from a nozzle towards a recording medium and an image is thereby recorded on the image recording medium.

Examples of the inkjet head include an inkjet head of a shuttle system in which a short serial head is used and recording is performed while allowing the head to scan in the across the width direction of a recording medium, and an inkjet head of a line system in which a line head in which recording elements are arranged corresponding to the entire region for one side of a recording medium is used. In the line system, an image can be recorded over the entire surface of the recording medium by allowing the recording medium to be scanned in the direction being perpendicular to the direction of aligning the recording elements, in which a transportation system such as a carriage by which the short head moves for scanning is not necessary. Further, since complicated scanning control for the movement of the carriage and the recording medium is not necessary and only the recording medium is moved, higher recording speed can be attained as compared with the shuttle system. While the image forming method in exemplary embodiments of the invention is applicable to any one of them, the effect of improving the ejection accuracy and the abrasion resistance of the image is generally remarkable when the inkjet recording method is applied to the line system without performing dummy jetting.

The amount of ink per one drop jetted from an inkjet head is preferably from 1 pL to 10 pL, and more preferably from 1.5 pL to 6 pL, from the viewpoint of obtaining a high-precision image. It is also effective to jet liquid droplets of different quantities in combination, with a view to suppressing unevenness in an image and improving smoothness in continuous gradation. The present invention is effective also in such an embodiment.

<Ink Removing Process>

The ink removing process in the present invention is a process of removing the ink composition (including adhered and solidified substances of the ink composition (adhered and solidified substances of ink); hereinafter, the same applies.) adhered to the inkjet head by using the above-described maintenance liquid in the present invention. Details, such as constitution and preferable embodiments, of the maintenance liquid used in this process are as described above.

In the ink removing process, in order to remove the ink composition from the nozzle face of the head, the maintenance liquid is applied to the head (for example, the vicinity of the head, ink channels, and the like; hereinafter, may also be referred to as “head and the like”). When the maintenance liquid is applied to the head and the like, the ink composition (for example, the adhered and solidified substance of ink) may dissolve or may swell.

Application of the maintenance liquid may be performed by, for example, ejection in accordance with an inkjet method, coating using a roller, spraying, or the like.

Further, before or after the application of the maintenance liquid, it is preferable to remove the ink composition by rubbing using a blade or wiping off using cloth or papers. Preferable examples of a method include a method of rubbing (wiping) the nozzle face using a wiper blade after applying the maintenance liquid, thereby rubbing off the ink composition, a method of removing the ink composition using wind pressure or liquid pressure of the maintenance liquid or the like, and a method of wiping off using cloth or papers.

The material of the wiper blade is preferably rubber having elasticity. Specific examples of the material include butyl rubber, chloprene rubber, ethylene propylene rubber, silicone rubber, urethane rubber, and nitrile rubber. A wiper blade coated with a fluororesin or the like in order to impart ink repellency to the wiper blade may also be used.

The amount of the maintenance liquid to be applied is not particularly limited as far as the amount is enough to dissolve or swell the ink composition, but the application amount of the maintenance liquid is preferably from 1 g/m² to 100 g/m².

<Treatment Liquid Applying Process>

It is preferable that the image forming method of the present invention further include a treatment liquid applying process of applying, onto a recording medium, a treatment liquid containing an aggregating agent that aggregates components in the ink composition.

In this process, the treatment liquid applied onto a recording medium is brought into contact with the ink composition which is applied onto the recording medium by the above ink composition applying process, to form an image. In this case, dispersed particles of the pigment, resin particles, or the like in the ink composition aggregate, and an image is fixed onto the recording medium. The treatment liquid contains at least an aggregating agent. Details of the respective components and preferred embodiments are as described above in the paragraph of “Treatment liquid”.

Application of the treatment liquid may be performed by applying known methods such as a coating method, an inkjet method, and an immersion method. The coating method may be performed by a known coating method using a bar coater, an extrusion die coater, an air doctor coater, a blade coater, a rod coater, a knife coater, a squeeze coater, or a reverse roll coater. Details of the inkjet method are as described above.

The treatment liquid applying process may be provided before or after the ink applying process using the ink composition.

In a preferable embodiment of the present invention, the ink applying process is provided after the treatment liquid applying process. In other words, in a preferable embodiment, the ink applying process described above is provided after the treatment liquid applying process, and the ink composition described above is applied onto the treatment liquid which has been applied onto a recording medium in the treatment liquid applying process. Specifically, in a preferable embodiment, before applying the ink composition onto a recording medium, the treatment liquid is applied in advance, and the ink composition is applied so as to contact with the treatment liquid that has been applied onto the recording medium, to form an image. Thereby, inkjet recording may be speeded-up and, even when high speed recording is performed, an image having high density and high resolution is obtained.

The amount of the treatment liquid to be applied in the treatment liquid applying process is not particularly limited as long as the ink composition can be coagulated, and is preferably 0.1 g/m² or more in terms of the amount of applied aggregating agent. The amount of the applied aggregating agent is more preferably from 0.2 g/m² to 0.7 g/m². When the amount of the applied aggregating agent is 0.1 g/m² or more, superior high-speed coagulation properties that accord with various modes of the use of the inkjet composition are maintained. A aggregating agent application amount of 0.7 g/m² or less is preferable in that advantageous influences, such as suppression of change in gloss and the like, are given to the surface properties of the recording medium to which the treatment liquid is applied.

According to exemplary embodiments of the invention, it is preferable to provide an ink applying process after the treatment liquid applying process, and to further provide a heating drying process of heating and drying the treatment liquid on the recording medium, between the time after applying the treatment liquid onto the recording medium, and the time until the ink composition is applied. By heating and drying the treatment liquid previously before the ink discharging process, ink coloring properties such as the prevention of bleeding becomes good, and visible images having good color density and hue can be recorded.

The heating and drying can be carried out by a known heating means such as heater, an air blowing means utilizing air blowing such as dryer, or a means combining these. Examples of the heating method include a method of supplying heat by a heater or the like, from the surface of the recording medium opposite the surface applied with the treatment liquid, a method of blowing a warm air or hot air to the surface of the recording medium applied with the treatment liquid, a method of heating using an infrared heater, or the like. Heating can also be performed by combining these methods.

<Curing Process>

It is preferable that the image forming method of the present invention further includes a curing process of irradiating the ink composition applied onto a recording medium in the ink applying process with actinic energy ray, to cure the ink composition.

Examples of the actinic energy ray, which may be used herein, include a ray, y ray, electron beam, X ray, ultraviolet ray, visible ray, and infrared ray. Among the above, ultraviolet ray is preferable.

By the curing process, monomer components (the polymerizable compound) in the ink composition can be reliably polymerized and cured. In this process, when a light source that emits the actinic energy ray is provided so as to face the recording surface of the recording medium and the entire recording surface is irradiated with the actinic energy ray, curing of the entire image formed by the application of the ink composition can be carried out. As the light source that emits the actinic energy ray, an ultraviolet ray irradiation lamp, a halogen lamp, a high pressure mercury lamp, a laser, an LED (light-emitting diode), an electron beam irradiation device, or the like may be used.

The curing process is provided after the ink applying process, however in a case in which the image forming method of the invention includes the treatment liquid applying process, it is preferable that the curing process is provided after the ink applying process and the treatment liquid applying process.

Irradiation condition of the actinic energy ray is not particularly restricted to as far as a polymerizable compound(s) may be polymerized therewith. The wavelength of the actinic energy ray is, for example, preferably from 200 nm to 600 nm, more preferably from 300 nm to 450 nm, and even more preferably from 350 nm to 420 nm, for example.

The power of the actinic energy ray is preferably 5,000 mJ/cm² or less, more preferably from 10 mJ/cm² to 4,000 mJ/cm², and even more preferably from 20 mJ/cm² to 3,000 mJ/cm².

<Recording Medium>

According to the image forming method of the present invention, an image is recorded on a recording medium.

The recording medium is not particularly limited, and may be a cellulose-based general printing paper, such as high-quality paper, coat paper, or art paper, which is used for general offset printing and the like. When image recording is performed on the cellulose-based general printing paper by a general inkjet process using an aqueous ink, absorption and drying of the ink is relatively slow, colorant migration easily occurs after ink spotting, and image quality tends to lower. In contrast, according to the image forming method of the present invention, a high-quality image recording having excellent color density and hue is achieved while suppressing the migration of the colorant.

As the recording medium, a recording medium which is generally commercially available may be used, and examples include high quality paper such as OK Prince High Quality (trade name, manufactured by Oji Paper Co., Ltd.), Shiraoi (trade name, manufactured by Nippon Paper Industries Co., Ltd.), and New NP High Quality (trade name, manufactured by Nippon Paper Industries Co., Ltd.), fine coated paper such as OK Ever Lite Coat (trade name, manufactured by Oji Paper Co., Ltd.) and Aurora S (trade name, Nippon Paper Industries Co., Ltd.), light coated paper (A3) such as OK Coat L (trade name, manufactured by Oji Paper Co., Ltd.) and Aurora L (trade name, manufactured by Nippon Paper Industries Co., Ltd.), coated paper (A2, B2) such as OK Top Coat+(trade name, manufactured by Oji Paper Co., Ltd.) and Aurora Coat (trade name, manufactured by Nippon Paper Industries Co., Ltd.), and an art paper (A1) such as OK Kanefuji+(trade name, manufactured by Oji Paper Co., Ltd.) and Tokubishi Art (trade name, manufactured by Nippon Paper Industries Co., Ltd.). Further, various papers for photography for use in inkjet recording methods may be used.

Among the recording media, a coated paper used in general offset printing is preferred. The coated paper is a product obtained by coating with a coating material the surface of a paper such as a high quality paper or neutral paper which is mainly based on cellulose and is not surface treated. The coated paper is likely to cause problems in product quality such as the gloss or abrasion resistance of images, in the conventional image formation by aqueous inkjet recording, but in the image forming method in exemplary embodiments of the invention, gloss irregularity is suppressed, and images having good glossiness and abrasion resistance are obtained. Particularly, it is preferable to use a coated paper having a base paper and a coating layer containing inorganic pigments, and more preferable to use a coated paper having a base paper and a coating layer containing kaolin and/or calcium bicarbonate. More specifically, art paper, coated paper, lightweight coated paper or finely coated paper is more preferred.

<Inkjet Recording Apparatus>

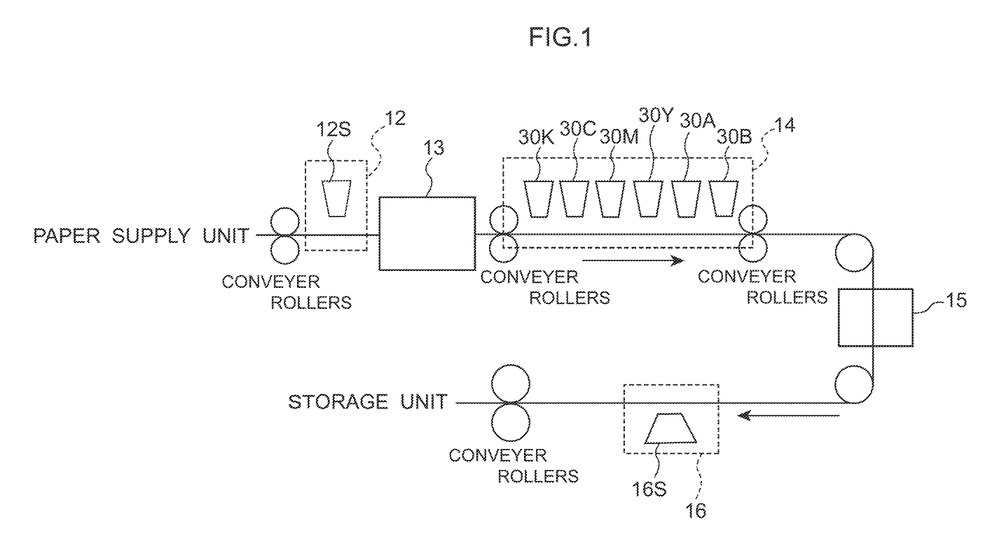

Next, an example of an inkjet recording apparatus favorably used in the image forming method in the present invention will be explained in detail with reference to FIG. 1.

FIG. 1 is a schematic view showing an example of a structure of the entire inkjet recording apparatus.

As shown in FIG. 1, the inkjet recording apparatus includes: treatment liquid application unit 12, having treatment liquid jetting head 12S that jets the treatment liquid; treatment liquid drying zone 13, having heating unit (not shown) that dries the applied treatment liquid; and ink jetting unit 14 that jets various ink compositions; and ink drying zone 15 at which the jetted ink composition is dried, in this order in the conveyance direction of the recording medium (the direction of the arrow shown in the FIGURE). Further, UV ray irradiation unit 16, having UV ray irradiation lamp 16S, is provided downstream of ink drying zone 15 in the conveyance direction of the recording medium.

The recording medium that has been supplied to the inkjet recording apparatus is conveyed by conveyance rollers (conveyer rollers) from a feed section (paper supply unit) to treatment liquid application unit 12, then to treatment liquid drying zone 13, then to ink jetting unit 14, then to ink drying zone 15, and then to UV ray irradiation unit 16, and then accumulated in an accumulation section (storage unit). The feed section feeds sheets of the recording medium from a case in which the sheets are loaded. The conveyance of the recording medium may be conducted by a method other than the method using conveyance rollers, and examples thereof include a drum conveyance method using a drum-shaped member, a belt conveyance method, or a stage conveyance method using a stage.

Among the plural conveyance rollers provided in the inkjet recording apparatus, at least one roller may be a drive roller to which the force generated by a motor (not shown) is transmitted. By rotating the drive roller at a constant rate using the motor, the recording medium is conveyed in a predetermined direction at a predetermined conveyance amount.

Treatment liquid application unit 12 has treatment liquid jetting head 12S, which is connected to a storage tank in which the treatment liquid is stored. Treatment liquid jetting head 12S jets the treatment liquid from jetting nozzles disposed to face the recording surface of the recording medium so that droplets of the treatment liquid can be applied onto the recording medium. The method used in treatment liquid application unit 12 is not limited to a method of jetting from a head in the form of a nozzle, and may be a coating method using a coating roller. According to the coating method, the treatment liquid may be readily applied to almost the entire one surface of the recording medium, including an image portion on which ink droplets are to be spotted by ink jetting unit 14 provided at the downstream side. In order to make uniform the thickness of the treatment liquid applied onto the recording medium, an air-knife may be used, or a method of providing a member having an acute angle to give a gap between the member and the recording medium that corresponds to the predetermined amount of treatment liquid may be adopted.

Treatment liquid drying zone 13 is positioned downstream of treatment liquid application unit 12 in the conveyance direction of the recording medium. Treatment liquid drying zone 13 may include: a known heating means such as a heater; an air blower such as a drier; or a combination thereof. The heating may be conducted by a method of disposing a heat-generating member, such as a heater, at a side of the recording medium opposite to the surface applied with the treatment liquid wherein, if the recording medium is conveyed automatically, the heat-generating member may be positioned, for example, below the conveyance system that conveys the recording medium placed thereon; or by a method of blowing warm or hot air onto the surface of the recording medium applied with treatment liquid; or by a method of using an infrared heater. Any of these methods may be used singly, or in combination of two or more thereof.

Since the surface temperature of the recording medium may vary depending on the type (material, thickness and the like) of the recording medium and the environmental temperature, it is preferable to form an applied treatment liquid layer while regulating the surface temperature by using a system including a measurement section that measures the surface temperature of the recording medium and a control section that provides the heating control unit with feedback on the temperature measured by the measurement section. The measurement section for measuring the surface temperature of the recording medium is preferably a contact-type or non-contact type thermometer.

The solvent may be removed using, for example, a solvent-removing roller. Alternatively, a method in which excess solvent is removed from the recording medium by an air knife is also applicable.

Ink jetting unit 14 is positioned downstream of treatment liquid drying zone 13 with respect to the conveyance direction of the recording medium. Ink jetting unit 14 includes recording heads (ink jetting heads) 30K, 30C, 30M and 30Y, which are connected to ink reservoirs that store inks of black (K), cyan (C), magenta (M) and yellow (Y), respectively. Each ink reservoir (not shown) stores an ink composition containing a pigment of a corresponding color, resin particles, water soluble organic solvent and water, and supplies the ink to the corresponding head among ink jetting heads 30K, 30C, 30M and 30Y, as necessary, when image recording is performed. Further, as shown in FIG. 1, recording heads 30A and 30B for jetting inks of specific colors may be further provided, which are positioned downstream of ink jetting heads 30K, 30C, 30M and 30Y with respect to the conveyance direction of the recording medium, such that recording heads 30A and 30B jet the inks having specific colors as necessary.

Ink jetting heads 30K, 30C, 30M and 30Y jet inks in a manner corresponding to the image to be formed, through jetting nozzles that are positioned so as to face the recording surface of the recording medium. In this way, inks of the respective colors are applied to the recording surface of the recording medium to form a color image.

Treatment liquid jetting head 12S and ink jetting heads 30K, 30C, 30M, 30Y, 30A and 30B are each in the form of full-line head in which a number of jetting ports (nozzles) are aligned along the maximum recording width of the image to be formed on the recording medium. In this form, image recording on a recording medium can be carried out at higher speed compared to serial-type recording in which recording is carried out using a short-length shuttle head that reciprocates in the width direction of the recording medium (in a direction on the plane of the recording medium that is perpendicular to the conveyance direction of the recording medium) in a scanning manner. In the present invention, either of the above serial-type recording method or a recording method capable of recording at relatively high speed, such as a single-path system in which an image is formed in one scanning-movement by jetting using a line head while moving the recording medium relative to the line head in the principal scanning direction, may be employed. In the image recording method of the present invention, a high-quality image having high reproducibility may be obtained even in the single-path system.

In the FIGURE, treatment liquid jetting head 12S and ink jetting heads 30K, 30C, 30M, 30Y, 30A and 30B have the same structure.

The application amount of the treatment liquid and the application amount of the ink composition are preferably regulated in accordance with the necessity. For example, the amount of the treatment liquid may be changed according to the type of the recording medium, in order to, for example, adjust the properties such as viscoelasticity of the aggregates formed upon mixing of the treatment liquid and the ink composition.

Ink drying zone 15 is positioned downstream of ink jetting unit 14 in the conveyance direction of the recording medium. Ink drying zone 15 may have a structure similar to that of treatment liquid drying zone 13.

UV ray irradiation unit 16 is disposed further downstream of ink drying zone 15 in the conveyance direction of the recording medium, and emits UV rays from UV ray irradiation lamp 16S provided in UV ray irradiation unit 16, thereby curing through polymerization of the monomer components contained in an image after drying of the image. UV ray irradiation lamp 16S is a lamp which is disposed to oppose the recording surface of the recording medium, and with which the entire recording surface is irradiated to cure the entire image. The lamp used in UV ray irradiation unit 16 is not limited to UV ray irradiation lamp 16S, and it is also possible to use a halogen lamp, a high-pressure mercury lamp, a laser, a LED, an electron-beam irradiation device, or the like.

The UV ray irradiation unit 16 may be disposed at either of before or after the ink drying zone 15, or at both of before and after the ink drying zone 15.

The inkjet recording apparatus may further include a heating unit at the conveyance path from the feed section to the accumulation section, in order to conduct a heat treatment on the recording medium. For example, by providing a heating unit at a desired position, such as upstream of treatment liquid drying zone 13 or between ink jetting unit 14 and ink drying zone 15, the temperature of the recording medium can be increased to a desired temperature, at which drying and fixing is performed effectively.

### EXAMPLES

Hereinafter, the present invention will be specifically described with reference to Examples, but the present invention is not limited to the following Examples. Unless stated otherwise, “parts” and “%” are based on mass. Note that, the unit of an SP value is (cal/cm³)^{1/2}.

<<Preparation of Water Dispersion of Self-Dispersing Resin Particles>>

Water dispersions of self-dispersing resin particles 1 to 11 shown in Table 1 and Table 2 below were prepared.

Hereinafter, preparation of the water dispersion of self-dispersing resin particles 2 in Table 1 and Table 2 (“No. 2” in Table 1 and Table 2) is explained mainly.

<Preparation of Water Dispersion of Self-Dispersing Resin Particles 2>

A water dispersion of self-dispersing resin particles 2 was prepared by using a phase inversion emulsification method. Detail preparation thereof is described below. 360.0 g of methyl ethyl ketone was placed in a 2 L three-necked flask equipped with a stirrer, a thermometer, a reflux condenser, and a nitrogen gas introduction tube, and was heated to 75° C. Thereafter, while the temperature inside the flask was maintained at 75° C., a mixture solution of 180.0 g of phenoxyethyl acrylate, 162.0 g of methyl methacrylate, 18.0 g of acrylic acid, 72 g of methyl ethyl ketone, and 1.44 g of V-601 (tradename, manufactured by Wako Pure Chemical Industries Ltd.) was added dropwise into the flask at a constant rate such that the dropwise addition was completed in 2 hours. After the dropwise addition was completed, a solution of 0.72 g of V-601 in 36.0 g of methyl ethyl ketone was added into the flask, stirred at 75° C. for 2 hours, and a solution of 0.72 g of V-601 in 36.0 g of isopropanol was further added, and the contents of the flask were stirred at 75° C. for 2 hours. Then, the temperature was increased to 85° C., and stirring was continued for another 2 hours. As a result, a resin solution of a copolymer of phenoxyethyl acrylate (PhoEA)/methyl methacrylate (MMA)/acrylic acid (AA) (in a ratio of 50/45/5 by mass) was obtained. The configuration ratio of the obtained copolymer was detected by H¹-NMR (proton nuclear magnetic resonance analysis).

The weight average molecular weight (Mw) of the obtained copolymer measured by GPC (gel permeation chromatography) was 64000. The acid value of the copolymer was found to be 38.9 mgKOH/g by using the method described in Japanese Industrial Standards (JIS K 0070 (1992)).

Then, 668.3 g of the obtained resin solution was weighed, and 388.3 g of isopropanol and 161.0 mL of a 1 mol/L NaOH aqueous solution were added to the resin solution, and then the temperature inside the reaction vessel was elevated to 80° C. (neutralization). Thereafter, 720.1 g of distilled water was added dropwise into the reaction vessel at a rate of 20 ml/min so as to form water dispersion. The contents of the reaction vessel was allowed to stand, under atmospheric pressure, at a reaction vessel inside temperature of 80° C. for 2 hours, and then 85° C. for 2 hours, and then 90° C. for 2 hours. Subsequently, the pressure inside of the reaction vessel was reduced, and the isopropanol, the methyl ethyl ketone, and the distilled water were removed in a total amount of 913.7 g. As a result, a water dispersion of self-dispersing resin particles 2 having a solid concentration of 28.0% by mass was obtained. A neutralization degree of the self-dispersing resin particles 2 was 0.8 in a ratio of mole equivalent. That is, 80% by number of the total number of the carboxyl groups contained in the copolymer of phenoxyethyl acrylate (PhoEA)/methyl methacrylate (MMA)/acrylic acid (AA) (in a ratio of 50/45/5 by mass) are neutralized and result in producing groups of —COONa.

The glass transition temperature (Tg) of the polymer that forms the self-dispersing resin particles 2 was measured according to the following method, and was found to be 50° C.

(Measurement of Glass Transition Temperature (Tg))

The water dispersion of the self-dispersing resin particles 2 in an amount of 0.5 g in terms of solid content was dried under reduced pressure at 50° C. for 4 hours to obtain a polymer solid fraction. The obtained polymer solid fraction was used to measure the Tg by a differential scanning calorimeter (DSC) EXSTAR6220 (trade name) manufactured by SII NanoTechnology Inc.

The measurement conditions were such that 5 mg of a sample was sealed in an aluminum pan, and the value of the peak top of DDSC from the measurement data obtained at the time of second temperature elevation in the following temperature profile under a nitrogen atmosphere was designated as Tg.

From 30° C. to −50° C. (cooled at a rate of 50° C./min),

from −50° C. to 120° C. (heated at a rate of 20° C./min),

from 120° C. to −50° C. (cooled at a rate of 50° C./min),

from −50° C. to 120° C. (heated at a rate of 20° C./min).

As shown in Table 1 and Table 2 below, the self-dispersing resin particles 2 are resin particles which is obtained by neutralizing a copolymer having a copolymerization mass ratio of [PhoEA/MMA/AA]=50/45/5 at a neutralization degree of 0.8.

As shown in Table 1 and Table 2 below, the SP values of the monomers, PhoEA, MMA, and AA are 10.41, 9.34, and 11.89, respectively.

In Table 1 and Table 2 below, the SP values of the monomers which form the resin that constitutes the self-dispersing resin particles 2 having a composition of PhoEA/MMA/AA are represented by “10.41/9.34/11.89”.

In Table 1 and Table 2, the SP values of monomers which form the resin that constitutes self-dispersing resin particles other than the self-dispersing resin particles 2 are also represented similarly.

<Preparation of Water Dispersion of Self-Dispersing Resin Particles 1 and 3 to 11>

Synthesis of self-dispersing resin particles 1 and 3 to 11 was conducted in a manner substantially similar to that in the synthesis of the self-dispersing resin particles 2 except that the composition and the copolymerization mass ratio were changed to those shown in Table 1 and Table 2 below by changing the kinds and amounts of monomers.

The weight average molecular weight (Mw), the glass transition temperature (Tg), and the SP values of monomers in each of the resins that constitute the self-dispersing resin particles 1 and 3 to 11 are as shown in Table 1 and Table 2 below.

In Table 1 and Table 2 below, the correspondence between the abbreviations of monomers and compound names is described below.

<<Preparation of Ink Composition>>

Cyan inks (C1) to (C11), magenta ink (M1), yellow ink (Y1), and black ink (K1) were each prepared as follows, as an ink composition.

<Preparation of Cyan Ink (C1)>

(Synthesis of Polymer Dispersant P-1)

88 g of methyl ethyl ketone were placed in a 1000 mL three-necked flask equipped with a stirrer and a condenser, and were heated to 72° C. under a nitrogen atmosphere. To this, a solution obtained by dissolving 0.85 g of dimethyl 2,2′-azobis(isobutyrate), 60 g of benzyl methacrylate, 10 g of methacrylic acid, and 30 g of methyl methacrylate in 50 g of methyl ethyl ketone was added dropwise over 3 hours. After the dropwise addition was completed, the mixture was reacted for an additional one hour, and then a solution obtained by dissolving 0.42 g of dimethyl 2,2′-azobis(isobutyrate) in 2 g of methyl ethyl ketone was added thereto. The temperature was raised to 78° C., and the mixture was heated for 4 hours. The resulting reaction liquid was reprecipitated twice in an excess amount of hexane, and the separated resin was dried to obtain 96 g of a polymer dispersant P-1 having a structure described below.

The composition of the obtained polymer dispersant P-1 was detected by ¹H-NMR. The weight average molecular weight (Mw) of the obtained polymer dispersant P-1 was 44,600. Further, the acid value of the polymer dispersant P-1 was found to be 65.2 mgKOH/g. Here, the weight average molecular weight and the acid value were measured by substantially the same methods as the methods explained in the above “Preparation of Water Dispersion of Self-dispersing Resin Particles”.

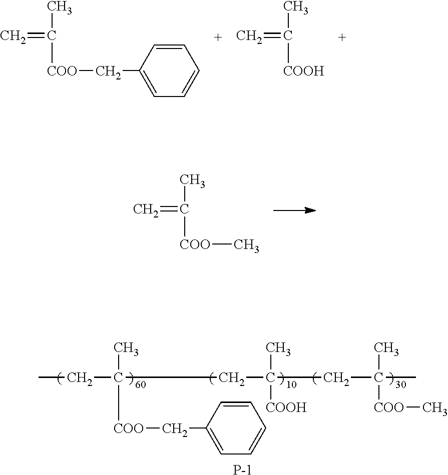

(Preparation of Resin-Coated Cyan Pigment Dispersion (C))

10 parts of a cyan pigment, Pigment Blue 15:3 (trade name: PHTHALOCYANINE BLUE A220, manufactured by Dainichiseika Color & Chemicals Mfg. Co., Ltd.), 5 parts of the above polymer dispersant P-1, 42 parts of methyl ethyl ketone, 5.5 parts of 1 mol/L NaOH aqueous solution, and 87.2 parts of ion exchanged water were mixed, and the resulting mixture was subjected to dispersion for a period of from 2 hours to 6 hours using a bead mill with zirconia beads having a diameter of 0.1 mm.

From the resulting dispersion, the methyl ethyl ketone was removed under reduced pressure at 55° C., and further a portion of water was removed, thereby obtaining a resin-coated cyan pigment dispersion (resin-coated cyan pigment dispersion (C)) having a pigment concentration of 10.2% by mass.

(Preparation of Cyan Ink (C1))

The respective components in the following composition were mixed, and then filtrated with a 5 μm membrane filter to prepare cyan ink (C1).

Composition of Cyan Ink (C1)

| | |
|---|---|
| Resin-coated cyan pigment dispersion (C) | 6% |
| obtained as described above | (concentration |
| | of solids) |
| IRGACURE 2959 (trade name, manufactured | 3% |
| by BASF Japan Ltd.; polymerization initiator) | |
| Polymerizable compound 2 described above | 20% |
| (polymerizable compound having | |
| an acrylamido structure) | |
| Water dispersion of | 7.1% |
| self-dispersing resin particles 1 | |
| OLFINE E1010 (trade name, manufactured | 1% |
| by Nissin Chemical Industry Co., Ltd.; surfactant) | |
| Ion exchanged water | Remainder |
| | (added to give |
| | 100% in total |
| | amount of the ink) |

The pH (at 25° C.) of the cyan ink (C1) was measured using PH METER WM-50EG (trade name, manufactured by DKK-TOA CORPORATION), and was found to be 8.5.

In the description hereinbelow, the apparatus and temperature for measuring the pH value are substantially the same as the measuring apparatus and temperature described above.

Polymerizable compound 2 was synthesized as follows. In a 1 L three-necked flask having a stirrer, 40.0 g (182 mmol) of 4,7,10-trioxa-1,13-tridecanediamine, 37.8 g (450 mmol) of sodium hydrogencarbonate, 100 g of water, and 300 mL of tetrahydrofuran were placed, and then 35.2 g (389 mmol) of acrylic acid chloride was added dropwise over 20 minutes under ice bath cooling. After the dropwise addition, the mixture was stirred at room temperature for 5 hours, and then the tetrahydrofuran was distilled off from the obtained reaction mixture under reduced pressure. Next, the aqueous layer was extracted 4 times with 200 ml of ethyl acetate, the obtained organic layer was dried over magnesium sulfate, filtration was performed, and the solvent was distilled off under reduced pressure, thereby obtaining 35.0 g (107 mmol, 59% yield) of a white solid of the polymerizable compound 2.

<Preparation of Cyan Inks (C2) to (C11)>

Preparation of cyan inks (C2) to (C11) was conducted in a manner substantially similar to that in the preparation of the cyan ink (C1), except that the self-dispersing resin particles 1 in the preparation of the cyan ink (C1) were changed to one of the self-dispersing resin particles 2 to 11 as shown in Table 1 below.

The pH values of the cyan inks (C2) to (C11) were all 8.5.

<Preparation of Magenta Ink (M1)>

Preparation of magenta ink (M1) was conducted in a manner substantially similar to that in the preparation of the cyan ink (C1), except that the cyan pigment, PHTHALOCYANINE BLUE A220 in the preparation of the cyan ink (C1) (specifically, in the preparation of the resin-coated cyan pigment dispersion (C)) was changed to a magenta pigment, CHROMOPHTHAL JET MAGENTA DMQ (trade name, manufactured by BASF Japan Ltd.; Pigment Red 122).

The pH value of the magenta ink (M1) was 8.5.

<Preparation of Yellow Ink (Y1)>

Preparation of yellow ink (Y1) was conducted in a manner substantially similar to that in the preparation of the cyan ink (C1), except that the cyan pigment, PHTHALOCYANINE BLUE A220 in the preparation of the cyan ink (C1) (specifically, in the preparation of the resin-coated cyan pigment dispersion (C)) was changed to a yellow pigment, IRGALITE YELLOW GS (trade name, manufactured by BASF Japan Ltd.; Pigment Yellow 74).

The pH value of the yellow ink (Y1) was 8.5.

<Preparation of Black Ink (K1)>

Preparation of black ink (K1) was conducted in a manner substantially similar to that in the preparation of the cyan ink (C1), except that the cyan pigment, PHTHALOCYANINE BLUE A220 in the preparation of the cyan ink (C1) (specifically, in the preparation of the resin-coated cyan pigment dispersion (C)) was changed to a black pigment, CAB-O-JET™ 200 (trade name, manufactured by Cabot Corporation). The pH value of the black ink (K1) was 8.5.

<<Preparation of Maintenance Liquid>>

<Preparation of Maintenance Liquid 1>

The respective components in the following composition were mixed, thereby preparing maintenance liquid 1.

The pH of the maintenance liquid 1 was 7.53.

In the following composition, the amount of hydrochloric acid corresponds to about 0.4 equivalents of tris(hydroxymethyl)aminomethane, in terms of acid equivalent.

Composition of Maintenance Liquid 1

| | |
|---|---|
| Diethylene glycol monobutyl ether (DEGmBE) | 25% |
| Tris(hydroxymethyl)aminomethane | 0.9% |
| 1N Hydrochloric acid | 3% |
| Ion exchanged water | 71.1% |

<Preparation of Maintenance Liquids 2 to 6>

Preparation of maintenance liquids 2 to 6 was conducted in a manner substantially similar to that in the preparation of the maintenance liquid 1, except that DEGmBE in the preparation of the maintenance liquid 1 was changed to an equal amount of the compound shown in Table 1 and Table 2 below.

The pH values of the maintenance liquids 2 to 6 were all 7.53.

The correspondence between the abbreviations of compounds in the maintenance liquids in Table 1 and Table 2 below and compound names is described below.

<<Preparation of Treatment Liquid>>

<Preparation of Treatment Liquid 1>

The respective components of the following composition were mixed, whereby treatment liquid 1 was prepared. The pH (at 25° C.) of the treatment liquid 1 was measured using PH METER WM-50EG (trade name, manufactured by DKK-TOA CORPORATION), and was found to be 1.0.

Composition of Treatment Liquid 1

| | |
|---|---|
| Malonic acid (manufactured by TATEYAMA | 25.0% |
| KASEI Co., Ltd.; acidic compound) | |
| Tripropylene glycol monomethyl ether | 5% |
| (water soluble organic solvent) | |
| Ion exchanged water | Remainder |
| | (added to give |
| | 100% in total amount |
| | of the treatment liquid) |

<Preparation of Treatment Liquid 2>

The respective components of the following composition were mixed, whereby treatment liquid 2 was prepared. After adjustment of pH with aqueous nitric acid, the pH (at 25° C.) of the treatment liquid 2 was measured using PH METER WM-50EG (trade name, manufactured by DKK-TOA CORPORATION), and was found to be 4.0.

Composition of Treatment Liquid 2

| | |
|---|---|
| Polyethyleneimine (manufactured by NIPPON | 13.0% |
| SHOKUBAI Co., Ltd.; cationic polymer) | |
| Ion exchanged water | Remainder |
| | (added to give 100% |
| | in total amount of the |
| | treatment liquid) |

<Preparation of Treatment Liquid 3>

The respective components of the following composition were mixed, whereby treatment liquid 3 was prepared. The pH (at 25° C.) of the treatment liquid 3 was measured using PH METER WM-50EG (trade name, manufactured by DKK-TOA CORPORATION), and was found to be 4.0.

Composition of Treatment Liquid 3

| | |
|---|---|
| Magnesium nitrate | 15% |
| Diethylene glycol monoethyl ether (manufactured by Wako Pure Chemical | 4% |
| Industries, Ltd.) | |
| Surfactant A (10%; structure: | 1% |
| C₇H₁₅—CH═CH—C₇H₁₄—C(═O)—N(CH₃)—CH₂CH₂—SO₃Na) | |
| Ion exchanged water | Remainder (added to give 100% in total |
| | amount of the treatment liquid) |

### Examples 1 to 24 and Comparative Examples 1 to 18

### Ink Set

Ink sets were prepared by using the ink, maintenance liquid, and treatment liquid prepared as described above in combination as shown in Table 1 and Table 2 below.

### <<Image Formation (Inkjet Recording)>>

Using the above ink set, image formation (inkjet recording) was carried out in a manner described below.

For the inkjet recording, OK TOP COAT+(trade name; basis amount: 104.7 g/m²) was prepared as the recording medium (coated paper).

Subsequently, using the ink set which had been prepared by using the ink and treatment liquid shown in Table 1 in combination, a line image and a solid image were formed by 4 color single pass recording.

First, an inkjet apparatus was prepared which has, as shown in FIG. 1, treatment liquid application unit 12 equipped with treatment liquid jetting head 12S that jets a treatment liquid, treatment liquid drying zone 13 that dries the applied treatment liquid, ink jetting unit 14 that jets various inks, ink drying zone 15 that dries the applied ink, and UV ray irradiation unit 16 equipped with UV ray irradiation lamp 16S capable of irradiating UV rays are provided sequentially in the conveyance direction of the recording medium (the direction of the arrow shown in the FIGURE).

Although not shown in the FIGURE, treatment liquid drying zone 13 has an air blower at the recording surface side of the recording medium that supplies dry air so as to dry the treatment liquid, and an infrared heater at the non-recording surface of the recording medium. Treatment liquid drying zone 13 is configured such that at least 70% by mass of the water contained in the treatment liquid is evaporated (dried) off during a period until 900 msec has passed after the application of the treatment liquid is started at the treatment liquid application unit, by regulating the temperature and air volume. In ink jetting unit 14, black-ink jetting head 30K, cyan-ink jetting head 30C, magenta-ink jetting head 30M, and yellow-ink jetting head 30Y are disposed in this order in the conveyance direction (the direction of the arrow). Each of the heads is a 1200 dpi/20 inch-wide full-line head. The respective heads are configured to jet inks of respective colors in a single-pass manner while moving in the principal scanning direction relative to the recording medium.

The treatment liquid 1, black ink K1, any one of cyan inks C1 to C11, magenta ink M1, and yellow ink Y1 were charged into storage tanks (not shown in the FIGURE) respectively connected to treatment jetting head and ink jetting heads of the inkjet apparatus that was configured as shown in FIG. 1, and a solid image and a 1200 dpi line image were recorded on sheets of a recording medium.

The line image was recorded by jetting in a single-pass manner so as to form a line of 1200 dpi having a width of 1 dot, a line of 1200 dpi having a width of 2 dots, and a line of 1200 dpi having a width of 4 dots along the principal scanning direction. Regarding the formation of the solid image, a sheet of the recording medium was cut into an A5-size, and a solid image was formed by jetting the ink onto the entire one surface of the sample. Conditions for the recording are described in the followings.

(1) Treatment Liquid Applying Process

The treatment liquid was ejected from the treatment liquid jetting head 12S in a single-pass manner onto the recording medium. The treatment liquid was ejected such that the application amount was 1.4 g/m².

(2) Treatment Process

Drying of the treatment liquid was conducted in the treatment liquid drying zone 13, and the recording medium applied with the treatment liquid was conveyed so as to pass through the treatment liquid drying zone during a period until 900 msec had passed after the ejection of the aqueous treatment liquid was started. With regard to the recording medium applied with the treatment liquid, drying treatment and permeation treatment were conducted under the following conditions.
Air velocity: 10 m/s
Temperature: the recording medium was heated, using a contact type plane heater, from the side opposite from (the rear side of) the recording surface of the recording medium, such that the surface temperature of the recording surface side of the recording medium was 60° C.

(3) Ink Applying Process

Thereafter, the black ink, cyan ink, magenta ink, and yellow ink were ejected from the ink jetting heads, in a single-pass manner, to the applying face of the recording medium which had been applied with the treatment liquid, thereby forming line images and solid images, respectively. Ejection of each ink was conducted under the following conditions.
Head: piezo full line heads with 1,200 dpi/20 inch width were arranged for 4 colors
Amount of ejected liquid per one drop: 2.0 pL
Driving frequency: 30 kHz

(4) Ink Drying Process

In the ink drying zone 15, the recording medium applied with the ink composition was dried under the following conditions.
Drying method: air blow drying
Air velocity: 15 m/s
Temperature: the recording medium was heated, using a contact type plane heater, from the side opposite from (the rear side of) the recording surface of the recording medium, such that the surface temperature of the recording surface side of the recording medium was 60° C.

(5) UV Ray Exposure Process

After drying the image, in the UV ray irradiation unit 16, the image was irradiated with UV rays (using a metal halide lamp manufactured by EYE GRAPHICS CO., LTD.; maximum wavelength of radiation: 365 nm) such that the integrated irradiation quantity was 3 J/cm², thereby curing the image.

(6) Fixing Process

Subsequently, thermal fixing treatment was carried out by allowing the recording medium to pass through between a pair of rollers under the following conditions.
Silicone rubber roller (hardness of 50°, and nip width of 5 mm)
Temperature of roller: 70° C.
Pressure: 0.2 MPa

<<Evaluation>>

With regard to the ink set prepared as described above and the images formed, the following evaluation was performed.

The evaluation results are shown in Table 1 and Table 2 below.

<Maintenance Property (Ink Removability)>

The ink included in the ink set was added onto a surface of a test piece described below by spraying to prepare an ink adhered substance having a droplet diameter of 50 μm, and the test piece was dried for one hour under an environment of 23° C. and 50% RH.

The material of the surface of this test piece was the same as the material of a liquid repellent film having a fluoroalkyl group, which is provided on the surface of a head base material in the inkjet recording apparatus.

After drying the ink adhered substance, the test piece was immersed in the maintenance liquid included in the same ink set for 1 second. Thereafter, the test piece was taken out from the maintenance liquid. The ink adhered substance was visually observed using a microscope, and an area of the ink adhered substance after immersion was determined.

—Evaluation Criteria—

A: ink adhered substance is not recognized at the surface of the test piece after immersion.

B: the area of the ink adhered substance after immersion is less than 5% with respect to the area of the ink adhered substance before immersion.

C: the area of the ink adhered substance after immersion is 5% or more but less than 10% with respect to the area of the ink adhered substance before immersion.

D: the area of the ink adhered substance after immersion is 10% or more with respect to the area of the ink adhered substance before immersion.

Note) the grades C and D are deemed as practically problematic.

<Re-Ejection Property of Ink after Maintenance>

The above ink set (the ink, the maintenance liquid, and the treatment liquid) was mounted in an inkjet printer obtained by modifying a printer GELJET GX5000 (trade name, manufactured by Ricoh Co., Ltd.).

Subsequently, the ink mounted in the inkjet printer was ejected in an amount of ink per one drop of 3.5 pL such that the amount of the ink applied was 5 g/m².

After the ejection, the maintenance liquid mounted in the inkjet printer was applied onto the nozzle face of the inkjet head using a roller. Thereafter, the nozzle face of the inkjet head was wiped using a wiper blade (made of a hydrogenized form of NBR (nitrile butadiene rubber)) (hereinafter, this operation is referred to as “maintenance”).

After the maintenance, the ink was ejected again.

The above operation was performed under the condition shown in the following (1) to (3), and in each condition, judgement of acceptance was performed.

(1) Just after the completion of continuous ejection for 60 minutes, blade wiping (maintenance) is carried out once. Thereafter, the ink is ejected again, and in a case in which the ink ejection ratio is 90% or higher, the ink set is judged to be acceptable.

(2) After ejection for 1 minute, the ejection is stopped for 30 minutes, and after the pause, blade wiping (maintenance) is carried out once. Thereafter, the ink is ejected again, and in a case in which the ink ejection ratio is 90% or higher, the ink set is judged to be acceptable.

(3) Just after the completion of ejection for 10 minutes, blade wiping (maintenance) is carried out once. Then, the ink is ejected again, and in a case in which no image unevenness is observed in the image that is formed by the re-ejection of ink, the ink set is judged to be acceptable.

—Measuring Method of Ink Ejection Ratio—

At the time of the initiation of the experiment, it was confirmed that the ink was ejected from all of the nozzles. Then, after the completion of the experiment including the maintenance, the number of ejection nozzles was counted, and the ink ejection ratio was calculated according to the following equation.

Ink ejection ratio (%)=[number of ejection nozzles after maintenance]/[total number of nozzles]×100(%)

Based on the results of the judgement of acceptance in the above (1) to (3), ink re-ejection property after maintenance was evaluated according to the following evaluation criteria.

—Evaluation Criteria of Ink Re-Ejection Property after Maintenance—

A: the case in which the ink set is judged to be acceptable in all of the three items.

B: the case in which the ink set is judged to be acceptable in two of the items.

C: the case in which the ink set is judged to be acceptable only in one of the items.

D: the case in which the ink set is judged to be not acceptable in all of the three items.

<Blocking Resistance of Image>

According to the method described in the above “Image Formation (Inkjet Recording)”, solid images (cyan solid images) were formed by using cyan inks (C1) to (C11), respectively. With regard to each of the formed cyan solid images, blocking resistance was evaluated as follows.

Immediately after printing (within 30 minutes after printing), a sheet of a recording medium on which nothing was recorded (the same recording medium as that used for recording; hereinafter referred to as “unused sample” in this evaluation) was placed on the solid image area having a size of 2 centimeters square in an A5-size sheet of a recording medium on which the cyan solid image had been recorded, and a load of 350 kg/m² was loaded. The assembly was left to stand for 24 hours under an environment of 60° C. and 30% RH. After leaving, the degree of ink transfer to the background portion of the unused sample was visually observed. Evaluation was made according to the following evaluation criteria.

—Evaluation Criteria—

A: ink transfer is not recognized at all.

B: ink transfer is hardly recognized.

C: ink transfer is recognized to some extent, which is deemed to be a practically acceptable limit.

D: ink transfer is remarkable.

Note) the grade D is deemed to be practically problematic.

TABLE 1

| | Ink | | | | | | | Maintenance | | | | | | |
|---|---|---|---|---|---|---|---|---|---|---|---|---|---|---|
| | | Self-dispersing resin particles | | | | | | Liquid | | | | Evaluation results | | |
| | | | composition | | | | | | Compound | | Treat. | Mainte- | Ink re- | Blocking |
| | | | (copolymer mass | | Tg | | Neut. | | | SP | Liq. | nance | ejection | Resis- |
| | No. | No. | ratio) | Mw | (° C.) | Each SP value | deg. | No. | Kind | value | No. | property | property | tance |
| Exam- | C1 | 1 | BzMA/MMA/ | 50000 | 80 | 10.33/9.34/11.37 | 0.8 | 1 | DEGmBE | 10.51 | 1 | A | A | A |
| ple 1 | | | MAA = | | | | | | | | | | | |
| | | | (50/44/6) | | | | | | | | | | | |
| Exam- | C2 | 2 | PhoEA/MMA/ | 64000 | 50 | 10.41/9.34/11.89 | 0.8 | 1 | DEGmBE | 10.51 | 1 | A | A | A |
| ple 2 | | | AA = | | | | | | | | | | | |
| | | | (50/45/5) | | | | | | | | | | | |
| Exam- | C3 | 3 | MMA/BMA/ | 55000 | 100 | 9.34/9.09/11.37 | 0.8 | 1 | DEGmBE | 10.51 | 1 | A | B | A |
| ple 3 | | | MAA = | | | | | | | | | | | |
| | | | (80/10/10) | | | | | | | | | | | |
| Exam- | C4 | 4 | MAA/MMA/ | 60000 | 90 | 11.37/9.34/11.89 | 0.8 | 1 | DEGmBE | 10.51 | 1 | B | B | A |
| ple 4 | | | AA = | | | | | | | | | | | |
| | | | (6/88/6) | | | | | | | | | | | |
| Exam- | C5 | 5 | MeoEA/MMA/ | 65000 | 75 | 9.41/9.34/11.37 | 0.8 | 1 | DEGmBE | 10.51 | 1 | B | B | A |
| ple 5 | | | MAA = | | | | | | | | | | | |
| | | | (50/40/10) | | | | | | | | | | | |
| Exam- | C6 | 6 | HEA/MMA/ | 68000 | 85 | 13.05/9.34/11.37 | 0.8 | 1 | DEGmBE | 10.51 | 1 | B | A | A |
| ple 6 | | | MAA = | | | | | | | | | | | |
| | | | (50/40/10) | | | | | | | | | | | |
| Exam- | C7 | 7 | DMA/MMA/ | 52000 | 80 | 8.84/9.34/11.37 | 0.8 | 1 | DEGmBE | 10.51 | 1 | B | B | A |
| ple 7 | | | MAA = | | | | | | | | | | | |
| | | | (10/80/10) | | | | | | | | | | | |
| Exam- | C8 | 8 | PEGA/MMA/ | 54000 | 70 | 9.48/9.34/11.37 | 0.8 | 1 | DEGmBE | 10.51 | 1 | B | B | A |
| ple 8 | | | MAA = | | | | | | | | | | | |
| | | | (10/80/10) | | | | | | | | | | | |
| Exam- | C1 | 1 | BzMA/MMA/ | 50000 | 80 | 10.33/9.34/11.37 | 0.8 | 2 | MEK | 8.98 | 1 | A | A | A |
| ple 9 | | | MAA = | | | | | | | | | | | |
| | | | (50/44/6) | | | | | | | | | | | |
| Exam- | C2 | 2 | PhoEA/MMA/ | 64000 | 50 | 10.41/9.34/11.89 | 0.8 | 2 | MEK | 8.98 | 1 | A | A | A |
| ple 10 | | | AA = | | | | | | | | | | | |
| | | | (50/45/5) | | | | | | | | | | | |
| Exam- | C3 | 3 | MMA/BMA/ | 55000 | 100 | 9.34/9.09/11.37 | 0.8 | 2 | MEK | 8.98 | 1 | A | B | A |
| ple 11 | | | MAA = | | | | | | | | | | | |
| | | | (80/10/10) | | | | | | | | | | | |
| Exam- | C4 | 4 | MAA/MMA/ | 60000 | 90 | 11.37/9.34/11.89 | 0.8 | 2 | MEK | 8.98 | 1 | B | B | A |
| ple 12 | | | AA = | | | | | | | | | | | |
| | | | (6/88/6) | | | | | | | | | | | |
| Exam- | C5 | 5 | MeoEA/MMA/ | 65000 | 75 | 9.41/9.34/11.37 | 0.8 | 2 | MEK | 8.98 | 1 | B | B | A |
| ple 13 | | | MAA = | | | | | | | | | | | |
| | | | (50/40/10) | | | | | | | | | | | |
| Exam- | C6 | 6 | HEA/MMA/ | 68000 | 85 | 13.05/9.34/11.37 | 0.8 | 2 | MEK | 8.98 | 1 | B | A | A |
| ple 14 | | | MAA = | | | | | | | | | | | |
| | | | (50/40/10) | | | | | | | | | | | |
| Exam- | C7 | 7 | DMA/MMA/ | 52000 | 80 | 8.84/9.34/11.37 | 0.8 | 2 | MEK | 8.98 | 1 | B | B | A |
| ple 15 | | | MAA = | | | | | | | | | | | |
| | | | (10/80/10) | | | | | | | | | | | |
| Exam- | C8 | 8 | PEGA/MMA/ | 54000 | 70 | 9.48/9.34/11.37 | 0.8 | 2 | MEK | 8.98 | 1 | B | B | A |
| ple 16 | | | MAA = | | | | | | | | | | | |
| | | | (10/80/10) | | | | | | | | | | | |
| Exam- | C1 | 1 | BzMA/MMA/ | 50000 | 80 | 10.33/9.34/11.37 | 0.8 | 3 | DEGmME | 11.22 | 1 | A | A | A |
| ple 17 | | | MAA = | | | | | | | | | | | |
| | | | (50/44/6) | | | | | | | | | | | |
| Exam- | C2 | 2 | PhoEA/MMA/ | 64000 | 50 | 10.41/9.34/11.89 | 0.8 | 3 | DEGmME | 11.22 | 1 | A | A | A |
| ple 18 | | | AA = | | | | | | | | | | | |
| | | | (50/45/5) | | | | | | | | | | | |
| Exam- | C3 | 3 | MMA/BMA/ | 55000 | 100 | 9.34/9.09/11.37 | 0.8 | 3 | DEGmME | 11.22 | 1 | A | B | A |
| ple 19 | | | MAA = | | | | | | | | | | | |
| | | | (80/10/10) | | | | | | | | | | | |
| Exam- | C4 | 4 | MAA/MMA/ | 60000 | 90 | 11.37/9.34/11.89 | 0.8 | 3 | DEGmME | 11.22 | 1 | B | B | A |
| ple 20 | | | AA = | | | | | | | | | | | |
| | | | (6/88/6) | | | | | | | | | | | |
| Exam- | C5 | 5 | MeoEA/MMA/ | 65000 | 75 | 9.41/9.34/11.37 | 0.8 | 3 | DEGmME | 11.22 | 1 | B | B | A |
| ple 21 | | | MAA = | | | | | | | | | | | |
| | | | (50/40/10) | | | | | | | | | | | |
| Exam- | C6 | 6 | HEA/MMA/ | 68000 | 85 | 13.05/9.34/11.37 | 0.8 | 3 | DEGmME | 11.22 | 1 | B | A | A |
| ple 22 | | | MAA = | | | | | | | | | | | |
| | | | (50/40/10) | | | | | | | | | | | |
| Exam- | C7 | 7 | DMA/MMA/ | 52000 | 80 | 8.84/9.34/11.37 | 0.8 | 3 | DEGmME | 11.22 | 1 | B | B | A |
| ple 23 | | | MAA = | | | | | | | | | | | |
| | | | (10/80/10) | | | | | | | | | | | |
| Exam- | C8 | 8 | PEGA/MMA/ | 54000 | 70 | 9.48/9.34/11.37 | 0.8 | 3 | DEGmME | 11.22 | 1 | B | B | A |
| ple 24 | | | MAA = | | | | | | | | | | | |
| | | | (10/80/10) | | | | | | | | | | | |

TABLE 2

| | Ink | | | | | | | Maintenance | | | | | | |
|---|---|---|---|---|---|---|---|---|---|---|---|---|---|---|
| | | Self-dispersing resin particles | | | | | | Liquid | | | | Evaluation results | | |
| | | | composition | | | | | | Compound | | Treat. | Mainte- | Ink re- | Blocking |
| | | | (copolymer mass | | Tg | | Neut. | | | SP | Liq. | nance | ejection | Resis- |
| | No. | No. | ratio) | Mw | (° C.) | Each SP value | deg. | No. | Kind | value | No. | property | property | tance |
| Comp. | C9 | 9 | IBOMA/MMA/ | 62000 | 155 | 9.82/9.34/11.37 | 0.8 | 1 | DEGmBE | 10.51 | 1 | D | D | A |
| Exp. 1 | | | MAA = | | | | | | | | | | | |
| | | | (50/40/10) | | | | | | | | | | | |
| Comp. | C9 | 9 | IBOMA/MMA/ | 62000 | 155 | 9.82/9.34/11.37 | 0.8 | 2 | MEK | 8.98 | 1 | C | C | A |
| Exp. 2 | | | MAA = | | | | | | | | | | | |
| | | | (50/40/10) | | | | | | | | | | | |
| Comp. | C1 | 1 | BzMA/MMA/ | 50000 | 80 | 10.33/9.34/11.37 | 0.8 | 4 | TMP | 15.91 | 1 | D | C | A |
| Exp. 3 | | | MAA = | | | | | | | | | | | |
| | | | (50/44/6) | | | | | | | | | | | |
| Comp. | C2 | 2 | PhoEA/MMA/ | 64000 | 50 | 10.41/9.34/11.89 | 0.8 | 4 | TMP | 15.91 | 1 | D | C | A |
| Exp. 4 | | | AA = | | | | | | | | | | | |
| | | | (50/45/5) | | | | | | | | | | | |
| Comp. | C3 | 3 | MMA/BMA/ | 55000 | 100 | 9.34/9.09/11.37 | 0.8 | 4 | TMP | 15.91 | 1 | D | D | A |
| Exp. 5 | | | MAA = | | | | | | | | | | | |
| | | | (80/10/10) | | | | | | | | | | | |
| Comp. | C4 | 4 | MAA/MMA/ | 60000 | 90 | 11.37/9.34/11.89 | 0.8 | 4 | TMP | 15.91 | 1 | D | D | A |
| Exp. 6 | | | AA = | | | | | | | | | | | |
| | | | (6/88/6) | | | | | | | | | | | |
| Comp. | C5 | 5 | MeoEA/MMA/ | 65000 | 75 | 9.41/9.34/11.37 | 0.8 | 4 | TMP | 15.91 | 1 | D | D | A |
| Exp. 7 | | | MAA = | | | | | | | | | | | |
| | | | (50/40/10) | | | | | | | | | | | |
| Comp. | C6 | 6 | HEA/MMA/ | 68000 | 85 | 13.05/9.34/11.37 | 0.8 | 4 | TMP | 15.91 | 1 | D | D | A |
| Exp. 8 | | | MAA = | | | | | | | | | | | |
| | | | (50/40/10) | | | | | | | | | | | |
| Comp. | C7 | 7 | DMA/MMA/ | 52000 | 80 | 8.84/9.34/11.37 | 0.8 | 4 | TMP | 15.91 | 1 | D | D | A |
| Exp. 9 | | | MAA = | | | | | | | | | | | |
| | | | (10/80/10) | | | | | | | | | | | |
| Comp. | C8 | 8 | PEGA/MMA/ | 54000 | 70 | 9.48/9.34/11.37 | 0.8 | 4 | TMP | 15.91 | 1 | D | D | A |
| Exp. 10 | | | MAA = | | | | | | | | | | | |
| | | | (10/80/10) | | | | | | | | | | | |
| Comp. | C10 | 10 | EIMA/MMA/ | 57000 | 85 | 8.75/9.34/11.37 | 0.8 | 1 | DEGmBE | 10.51 | 1 | D | D | A |
| Exp. 11 | | | MAA = | | | | | | | | | | | |
| | | | (50/40/10) | | | | | | | | | | | |
| Comp. | C11 | 11 | HEAA/MMA/ | 53000 | 80 | 15.21/9.34/11.37 | 0.8 | 1 | DEGmBE | 10.51 | 1 | D | D | A |
| Exp. 12 | | | MAA = | | | | | | | | | | | |
| | | | (50/40/10) | | | | | | | | | | | |
| Comp. | C1 | 1 | BzMA/MMA/ | 50000 | 80 | 10.33/9.34/11.37 | 0.8 | 5 | n-HEX | 7.28 | 1 | C | D | A |
| Exp. 13 | | | MAA = | | | | | | | | | | | |
| | | | (50/44/6) | | | | | | | | | | | |
| Comp. | C3 | 3 | MMA/BMA/ | 55000 | 100 | 9.34/9.09/11.37 | 0.8 | 5 | n-HEX | 7.28 | 1 | C | D | A |
| Exp. 14 | | | MAA = | | | | | | | | | | | |
| | | | (80/10/10) | | | | | | | | | | | |
| Comp. | C6 | 6 | HEA/MMA/ | 68000 | 85 | 13.05/9.34/11.37 | 0.8 | 5 | n-HEX | 7.28 | 1 | C | D | A |
| Exp. 15 | | | MAA = | | | | | | | | | | | |
| | | | (50/40/10) | | | | | | | | | | | |
| Comp. | C1 | 1 | BzMA/MMA/ | 50000 | 80 | 10.33/9.34/11.37 | 0.8 | 6 | 1,6-HDO | 13.52 | 1 | D | C | A |
| Exp. 16 | | | MAA = | | | | | | | | | | | |
| | | | (50/44/6) | | | | | | | | | | | |
| Comp. | C3 | 3 | MMA/BMA/ | 55000 | 100 | 9.34/9.09/11.37 | 0.8 | 6 | 1,6-HDO | 13.52 | 1 | D | D | A |
| Exp. 17 | | | MAA = | | | | | | | | | | | |
| | | | (80/10/10) | | | | | | | | | | | |
| Comp. | C6 | 6 | HEA/MMA/ | 68000 | 85 | 13.05/9.34/11.37 | 0.8 | 6 | 1,6-HDO | 13.52 | 1 | D | D | A |
| Exp. 18 | | | MAA = | | | | | | | | | | | |
| | | | (50/40/10) | | | | | | | | | | | |

In tables 1 and 2, the abbreviation “Treat. Liq.” represents “Treatment liquid”, and the abbreviation “Neut. deg.” represents “Neutralization degree”. In table 2, the abbreviation “Comp. Exp.” represents “Comparative Example”.

<Explanation of Table 1 and Table 2>
The unit of the SP value in Table 1 and Table 2 is (cal/cm³)^{1/2}.
In Table 1 and Table 2, the correspondence between the abbreviations of monomers and compound names is as follows.

(Correspondence between Abbreviations of Monomers and Compound Names)

BzMA: benzyl methacrylate

PhoEA: phenoxyethyl acrylate

MMA: methyl methacrylate

BMA: butyl methacrylate

MAA: methacrylic acid

AA: acrylic acid

MeoEA: methoxyethyl acrylate

HEA: hydroxyethyl acrylate

DMA: dodecyl methacrylate

PEGA: polyethylene glycol acrylate (in which the number of the repeated structural units derived from ethylene glycol is 100)

IBOMA: isobornyl methacrylate

EIMA: eicosyl methacrylate

HEAA: 2-hydroxyethyl acrylamide
In Table 1 and Table 2, the correspondence between the abbreviations of compounds in the maintenance liquids and compound names is as follows.

(Abbreviations of Compounds in the Maintenance Liquid and Compound Names)

DEGmBE: diethylene glycol monobutyl ether

MEK: methyl ethyl ketone

DEGmME: diethylene glycol monomethyl ether

TMP: trimethylolpropane

n-HEX: n-hexane

1,6-HDO: 1,6-hexanediol

As shown in Table 1 and Table 2, in Examples 1 to 24, the maintenance property and the re-ejection property after maintenance were excellent. Further, in Examples 1 to 24, images having excellent blocking resistance were formed.

In contrast, in Comparative Examples 1 and 2 in which the resin that forms the resin particles in the ink contains a structural unit that does not correspond to any of structural units represented by Formula (1) and structural units having an acidic group or a salt thereof, in Comparative Example 11 which contains a structural unit derived from a polymerizable compound having an SP value of less than 8.80 (cal/cm³)^{1/2}, in Comparative Example 12 which contains a structural unit derived from a polymerizable compound having an SP value of more than 14.00 (cal/cm³)^{1/2}, in Comparative Examples 13 to 15 in which the SP value of the compound in the maintenance liquid is less than 8.00 (cal/cm³)^{1/2}, and in Comparative Examples 3 to 10 and 16 to 18, in which the SP value of the compound in the maintenance liquid exceeds 12.00 (cal/cm³)^{1/2}, the maintenance property and the re-ejection property after maintenance were deteriorated.

Next, evaluation of blocking resistance was performed in a manner substantially similar to that in Examples 1 to 24 except that the treatment liquid 1 was changed to the treatment liquid 2 or the treatment liquid 3. As a result, in both the case of using the treatment liquid 2 and the case of using the treatment liquid 3, images having excellent blocking resistance were formed similar to Examples 1 to 24 in which the treatment liquid 1 was used.

The foregoing description of the exemplary embodiments of the present invention has been provided for the purposes of illustration and description. It is not intended to be exhaustive or to limit the invention to the precise forms disclosed. The embodiments were chosen and described in order to best explain the principles of the invention and its practical applications, thereby enabling others skilled in the art to understand the invention for various embodiments and with the various modifications as are suited to the particular use contemplated.

All publications, patent applications, and technical standards mentioned in this specification are herein incorporated by reference to the same extent as if such individual publication, patent application, or technical standard was specifically and individually indicated to be incorporated by reference. It will be obvious to those having skill in the art that many changes may be made in the above-described details of the preferred embodiments of the present invention. It is intended that the scope of the invention be defined by the following claims and their equivalents.

What is claimed is:

1. An ink set comprising:
an ink composition comprising:
resin particles including:
a polymer formed from one or more structural units selected from structural units, which are represented by the following Formula (1) and are derived from a polymerizable compound having an SP value of from 8.80 (cal/cm³)^{1/2} to 14.00 (cal/cm³)^{1/2}, and one or more structural units selected from the group consisting of structural units having an acidic group and structural units having a salt of an acidic group;
a polymerizable compound having a (meth)acrylamido structure;
water;
a pigment; and
a polymerization initiator; and
a maintenance liquid comprising a compound having an SP value of from 8.00 (cal/cm³)^{1/2} to 12.00 (cal/cm³)^{1/2}, 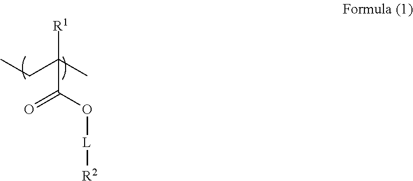
wherein, in Formula (1), R¹ represents a hydrogen atom or a methyl group; L represents a single bond or a divalent linking group; R² represents a hydrogen atom, a straight chain or branched alkyl group having 1 to 12 carbon atoms, an aryl group having 6 to 10 carbon atoms or an aralkyl group having 7 to 12 carbon atoms; and when R² represents a hydrogen atom, L represents a divalent linking group.

2. The ink set according to claim 1, wherein, in Formula (1), L represents a single bond or a group represented by —((CH₂)ₙO)ₘ—*; m and n each independently represent an integer of 1 or more; and * represents a bond position with R².

3. The ink set according to claim 1, wherein a glass transition temperature of the polymer that is comprised in the resin particles is less than 150° C.

4. The ink set according to claim 1, wherein the resin particles are prepared by using a phase inversion emulsification method.

5. The ink set according to claim 1, wherein a content of the one or more structural units which are represented by Formula (1) and are derived from a polymerizable compound having an SP value of from 8.80 (cal/cm³)^{1/2} to 14.00 (cal/cm³)^{1/2} is 80% by mass to 98% by mass, and a content of the one or more structural units selected from the group consisting of structural units having an acidic group and structural units having a salt of an acidic group is 2% by mass to 20% by mass, with respect to a total amount of the polymer that is comprised in the resin particles.

6. The ink set according to claim 1, wherein the polymerizable compound having the (meth)acrylamido structure is a polyfunctional polymerizable compound represented by the following Formula (2): 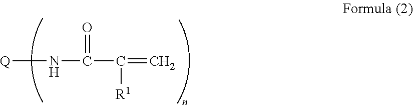
wherein, in Formula (2), Q represents an n-valent linking group; R¹ represents a hydrogen atom or a methyl group; and n represents an integer from 2 to 6.

7. The ink set according to claim 6, wherein, in Formula (2), Q represents a residue group that is formed by eliminating two or more selected from hydrogen atom(s), hydroxyl group(s) or any combination thereof, from a polyol containing two or more oxyalkylene groups.

8. The ink set according to claim 1, wherein the maintenance liquid further comprises an organic basic compound and an acidic compound.

9. The ink set according to claim 8, wherein a pKa value of a conjugate acid of the organic basic compound is in a range of from 6.0 to 8.5.

10. The ink set according to claim 8, wherein the acidic compound is at least one inorganic acid selected from the group consisting of hydrochloric acid, sulfuric acid, sulfurous acid, nitric acid and phosphoric acid.

11. The ink set according to claim 1, further comprising a treatment liquid containing a coagulating agent capable of coagulating a component(s) in the ink composition.

12. The ink set according to claim 11, wherein the coagulating agent is at least one selected from the group consisting of an acidic compound, a multivalent metal salt and a cationic polymer.

13. An image forming method using the ink set according to claim 1, the method comprising an ink applying process that applies the ink composition by discharging from an inkjet head onto a recording medium; and an ink removing process that removes the ink composition which has been adhered to the inkjet head by using the maintenance liquid.

14. The image forming method according to claim 13, further comprising a curing process that cures the ink composition by irradiating an actinic energy ray onto the ink composition that has been applied onto the recording medium.

15. The image forming method according to claim 13, further comprising a treatment liquid applying process that includes applying, onto the recording medium, a treatment liquid containing a coagulating agent capable of coagulating a component(s) in the ink composition.

16. The image forming method according to claim 15, wherein the ink applying process is performed after the treatment liquid applying process, and applies the ink composition onto the treatment liquid that has been applied onto the recording medium.

17. The image forming method according to claim 13, wherein the recording medium is a coated paper which comprises base paper and a coated layer containing an inorganic pigment.
